(19) United States
(12) Patent Application Publication
(10) Pub. No.: US 2014/0297770 A1
(43) Pub. Date: Oct. 2, 2014

(54) ELECTRONIC MESSAGE SYSTEM FOR SOLICITING REPLY

(71) Applicant: Rakus Co., Ltd., Osaka (JP)

(72) Inventor: Tetsuya Wada, Tokyo (JP)

(73) Assignee: Rakus Co., Ltd., Osaka (JP)

(21) Appl. No.: 14/227,200

(22) Filed: Mar. 27, 2014

(30) Foreign Application Priority Data
Mar. 29, 2013 (JP) 2013-70871
Mar. 29, 2013 (JP) 2013-70872

(51) Int. Cl. H04L 12/58

(52) U.S. Cl. CPC H04L 51/02
USPC 709/206

(57) ABSTRACT

An apparatus includes a memory and a processor coupled to the memory. The processor may receive a user generated electronic message. The processor may also send a first electronic message to a designated receiver, where the first electronic message solicits a response from the designated receiver regarding the user generated electronic message. The processor may also send a plurality of subsequent electronic messages to the designated receiver according to a repeat-notification schedule stored in the memory until the response is received, where the plurality of subsequent electronic messages solicit the response. The repeat-notification schedule includes a first elapsed time before sending of a second electronic message occurs and a second elapsed time before sending of a third electronic message occurs, where the second elapsed time is different than the first elapsed time.

### CROSS-REFERENCE TO RELATED APPLICATIONS

The present application claims priority to Japanese patent applications JP2013-70871 and JP2013-70872, both filed on Mar. 29, 2013, the entire disclosures of which are incorporated herein by reference.

### BACKGROUND

Electronic communication is very prevalent. Many people communicate through electronic mail, or email. Those communicating by email can send a message to another email user if they know the email “address” to send a message to. These addresses are often a sequence of letters, numbers, and symbols that uniquely identify an email user. Different providers or servers may office email services, but those services may all be in communication via the internet. Thus, email users may be able to communicate regardless of who or what entity provides their email service.

Other modes of electronic communication are also available to those who would like to communicate with others. For example, short message service (SMS) can be used to communicate with others. SMS services often use cellular telephone networks to send a short message of text to another user. In this situation, an SMS text may be sent to a particular telephone number. Some SMS services have expanded to allow the sending of photographs, audio, video, and hyperlinks.

Another way people may communicate electronically is through the use of social networks (also referred to herein as a social networking service, social networking site, or SNS). On some social networks, an instant messaging service is available. Another way individuals may communicate on social networks is by sending email like messages to other users of the social network. Another way to communicate using social media may be through a public posting of a message, allowing interested parties to view and respond to the message as each viewer sees fit.

Through the different mediums of communication, a user may communicate with one individual, or with any different number of individuals. A user may also communicate with users that represent entities. In addition to sending a message using an electronic medium, a user may receive messages. A user may also respond to any received messages.

### SUMMARY

An apparatus includes a memory and a processor coupled to the memory. The processor may receive a user generated electronic message. The processor may also send a first electronic message to a designated receiver, where the first electronic message solicits a response from the designated receiver regarding the user generated electronic message. The processor may also send a plurality of subsequent electronic messages to the designated receiver according to a repeat-notification schedule stored in the memory until the response is received, wherein the plurality of subsequent electronic messages solicit the response. The repeat-notification schedule includes a first elapsed time before sending of a second electronic message occurs and a second elapsed time before sending of a third electronic message occurs, where the second elapsed time is different than the first elapsed time.

A method includes receiving, by a processor of a terminal, a user generated electronic message. The method also includes sending, by the processor of the terminal, a first electronic message to a designated receiver, where the first electronic message solicits a response from the designated receiver regarding the user generated electronic message. The method also includes sending, by the processor of the terminal, a plurality of subsequent electronic messages to the designated receiver according to a repeat-notification schedule stored in a memory until the response is received, where the plurality of subsequent electronic messages solicit the response. The repeat-notification schedule includes a first elapsed time before sending of a second electronic message occurs and a second elapsed time before sending of a third electronic message occurs, where the second elapsed time is different than the first elapsed time.

A non-transitory computer readable medium having instructions stored thereon for execution by a processor includes instructions to receive, by a processor, a user generated electronic message. The computer readable medium also includes instructions to send, by the processor, a first electronic message to a designated receiver, where the first electronic message solicits a response from the designated receiver regarding the user generated electronic message. The computer readable medium also includes instructions to send, by the processor, a plurality of subsequent electronic messages to the designated receiver according to a repeat-notification schedule stored in the non-transitory computer readable medium until the response is received, where the plurality of subsequent electronic messages solicit the response. The repeat-notification schedule includes a first elapsed time before sending of a second electronic message occurs and a second elapsed time before sending of a third electronic message occurs, where the second elapsed time is different than the first elapsed time.

### BRIEF DESCRIPTION OF THE DRAWINGS

Illustrative embodiments will hereafter be described with reference to the accompanying drawings.

FIG. 1 is a diagram of an overall configuration representing a network system in accordance with an illustrative embodiment.

FIG. 2 is a block diagram representing an SNS server component in accordance with an illustrative embodiment.

FIG. 3 is a block diagram representing a cloud server component in accordance with an illustrative embodiment.

FIG. 4 is a block diagram representing one mode of embodying a client terminal in a client component in accordance with an illustrative embodiment.

FIG. 5 is a functional block diagram for an occasion when a posting module stored in a posting-module memory in a cloud server component is executed by a module-execution unit in a client terminal in accordance with an illustrative embodiment.

FIG. 6 is a functional block diagram for an occasion when a monitor module stored in a monitor-module memory in a cloud server component is executed by a module-execution unit in a client terminal in accordance with an illustrative embodiment.

FIG. 7 is a functional block diagram for an occasion when an assign module stored in an assign-module memory in a cloud server component is executed by a module-execution unit in a client terminal in accordance with an illustrative embodiment.

FIG. 8 is a functional block diagram for an occasion when a case-management module stored in a case-management-module memory in a cloud server component is executed by a module-execution unit in a client terminal in accordance with an illustrative embodiment.

FIG. 9 is a functional block diagram for an occasion when an intelligent-email module stored in an intelligent-email-module memory in a cloud server component is executed by an intelligent-email processing unit in accordance with an illustrative embodiment.

FIG. 10 is a flowchart representing a procedure for a posting process in accordance with an illustrative embodiment.

FIG. 11 is a flowchart representing a procedure for a monitor process in accordance with an illustrative embodiment.

FIG. 12 is a flowchart representing a procedure for an assign process in accordance with an illustrative embodiment.

FIG. 13 is a flowchart for representing procedural steps in a case-management process in accordance with an illustrative embodiment.

FIG. 14 is a flowchart representing a procedure for a User-Response Emailing Process I, executed upon a send destination being designated in a posting process in accordance with an illustrative embodiment.

FIG. 15 is a flowchart representing a procedure for a User-Response Emailing Process II, executed in a posting process in accordance with an illustrative embodiment.

FIG. 16 is a flowchart representing a process, executed by an intelligent-email processing unit, for when email replying to a request email for an assign has been received in accordance with an illustrative embodiment.

FIG. 17 is a flowchart representing a procedure for an intelligent-email process executed by an intelligent-email processing unit in accordance with an illustrative embodiment.

FIG. 18 is a diagram representing a starting screen in accordance with an illustrative embodiment.

FIG. 19 is a diagram representing an after-switching screen in an instance where a posting-module radio button has been selected in accordance with an illustrative embodiment.

FIG. 20 is a diagram representing an after-switching screen in an instance where a monitor-module radio button has been selected through a starting screen after login in accordance with an illustrative embodiment.

FIG. 21 is a diagram representing a search results screen in accordance with an illustrative embodiment.

FIG. 22 is a diagram representing one example of an assign-request email drafting screen in accordance with an illustrative embodiment.

FIG. 23 is a diagram representing one example of a case-management mode screen in accordance with an illustrative embodiment.

### DETAILED DESCRIPTION

In the following, several embodiments will be described. It should be understood that the described embodiments do not unwarrantedly limit the scope of the patent claims. Further, all of the configurations and functions that are described in the embodiments are not necessarily items indispensable to all embodiments disclosed herein.

The embodiments disclosed herein relate to information-processing technology for supporting the administration of email carried out among terminals via a network.

Social networks have become commonplace in recent years. Even in the business world, for example, the back-and-forth of electronic-mail correspondence to exchange desired information takes place among terminals by way of the Internet. Email is found by many to be highly convenient, given that transmission of messages is carried out even if the terminal on the other party's end is not started up. However, if an email sender does not receive a desired reply email, it may be difficult to get information from the receiving party. In cases like this an email sender may repeat transmission of the email any number of times.

Japanese Unexamined Pat. App. Pub. No. 2002-64532 describes, in Paragraphs [0011] through [0014], a method of transmitting a given email message at fixed intervals, by establishing an hour, day, week, month, etc. repetition interval. Japanese Unexamined Pat. App. Pub. No. H09-139752 describes the soliciting, within email that a sender transmits, of a reply from the recipient (Paragraph [0005]). The publication also describes a technology whereby a reply-reminder email is sent to the other party's terminal at a predetermined date and time or a designated frequency is described (Paragraph [0026]). Furthermore, Paragraph [0036] states that “predetermined date and time” is, for example, a transmission date and time several days prior to the reply time limit, and that “designated frequency” is respective dates and times for repeated transmission of reply-reminder email within a designated time period prior to the reply time limit.

With Japanese Unexamined Pat. App. Pub. No. 2002-64532 and Japanese Unexamined Pat. App. Pub. No. H09-139752, the fact that email is transmitted according to a fixed repetition frequency over a long term means that the same transmission emails accumulate in large quantity within the receiver's electronic-mail inbox. Consequently, if among them are other email messages, important email is mixed in, and there is a risk that the important email will be forgotten or accidentally deleted. Such retransmission of emails in this manner may also cause an undesirable increase in network traffic.

In an illustrative embodiment, brought about in view of the foregoing, is to make available service-support servers, information processing methods, and devices that are capable of repeat-transmitting an outgoing email message for soliciting reply email. This repeat-transmission is done using varying intervals of time that little by little lengthen, prolong, or increase the intervals between the transmissions. This system may make it possible to enable notification, solicit a reply, and even bring about a sense of urgency for the receiver. Additionally, the system is more efficient in keeping the overall number of emails down to as few as feasible, even when there is no reply for a long while.

In an illustrative embodiment, in a service-support server for supporting the administration of email carried out among terminals via a network, is furnished with: a server memory section including an advance-storing module for download to and execution in a terminal, and the advance-storing module is capable of carrying out an outgoing email transmission process and a process of receiving email in reply to the outgoing email; a communications unit for receiving from said terminal a solicitation for carrying out an initial outgoing email, and for downloading from said server memory section to said terminal a module for an outgoing email transmission process; an administration unit for administering the presence/absence of reply-email reception with respect to the outgoing email; a repeat-notification schedule memory section storing an outgoing email repeat-notification schedule; and a repeat-notification processor for carrying out, per the repeat-notification schedule, transmission to a terminal other than said terminal until a reply email to the outgoing email is received. The repeat-notification schedule is established in such a way that intervals between notifications gradually lengthen.

In an illustrative embodiment, when there is a solicitation for carrying out an initial outgoing email from a terminal, a module for an outgoing email transmission process is downloaded from the server memory section to the terminal by the communications unit. Using the downloaded outgoing email transmission process, the process of transmitting the initial outgoing email is carried out and sent to a designated receiver. After that, the presence/absence of a reply-email reception is administered by the administration unit, and until a reply email is received from the designated receiver, the process of transmitting to another terminal is carried out by the repeat-notification processor per the repeat-notification schedule. In one embodiment, the intervals between notifications in the repeat-notification schedule are lengthened little by little allowing for close-together notifications at the initial stage. The repeat-notification may allow for, with the elapse of time, the intervals between emails or notifications to be extended, keeping the number of email messages as a whole down to as few as feasible. It will be appreciated that the email could be or could include a short message service (SMS) or other type of electronic communication. Also, a system that allows logging in to a given server device and receiving a provision of services is contemplated. In such a service, a logged in user may send a notification email from a logged-in transmission-originating terminal. The system may identify that the notification email has been sent and is incoming, and may also identify the logged in user and/or the originating terminal. The possibility of a transmission destination of an outgoing email being logged out is another condition that may be recognized by the system. The system may operate in a certain mode or set a particular repeat-notification schedule based on all of these factors. In other words, the present service support used is configured for the factors present. Further, the system may also be applicable to situations in which simple email exchanges between two parties via a network are carried out. The system may also be made to execute such a repeat notification-email transmission process in the context of an online chat. This may include the situation where the other party is away (is not logged in).

Further, the system may present or use a plurality of repeat-notification schedules in which the gradually lengthening notification intervals differ. Accordingly, in situations where the status of the party or characteristics of the destination receiving the notification are known—e.g., like the size of the party's workload, type of transmission, log-in state of the party, or other factors—the repeat-notification schedule is advantageously selected on the sender's end according to a guidebook, automatically by the system, or manually by the sender. Alternatively, the configuration may be such that the repeat-notification schedule is advantageously selected according to time factors, such as when a reply to the notification is needed.

The extent of the gradual lengthening in the repeat-notification schedule may also differ according to the transmitted-to party. In accordance with attributes of the transmitted-to party, a more favorable repeat-notification schedule can be selected.

The outgoing email may also be linked to the email address of a third-party terminal and to a to-be-watched post sent on the network from the third-party terminal. The to-be-watched post may be a request to follow-up on the post from the third party. Accordingly, even when there is no reply for a long while to an outgoing email message requesting follow-up on a post from a third party, the number of messages sent can be kept down to as few as feasible, while still calling attention to the post from the third party with a sense of urgency.

In another embodiment, the extent of the gradual lengthening in the repeat-notification schedule may be made to differ according to the content of the post. Accordingly, if the posted material is an important case that requires urgency (or has a high level of influence), the system or user may select a repeat-notification schedule in which the intervals between repeat notifications are shorter, which enables responding optimally to the sense of urgency, etc.

A final notification may also be set in the repeat-notification schedule. In the final notification, the repeat-notification processor may carry out transmission of the final notification to a specified terminal different from the aforementioned other terminal. Accordingly, a final notification may be transmitted to a specified terminal in cases where reply email is not sent in return even though the repeat-notification has been carried out. For example, the head of the transmitted-to party's department, or to the terminal of someone who has been registered in advance as another point of contact may receive the final notification, which may help to overcome a situation of not getting through to the originally specified terminal.

The system may also have an information processing device for administering email, which may include: memory storing an outgoing email repeat-notification schedule; an administration unit for administering outgoing email and the reception of reply-email with respect to the outgoing email; and a repeat-notification processor for carrying out, per the repeat-notification schedule, transmission to outside terminals until a reply email to the outgoing email is received. Additionally, the repeat-notification schedule may be established in such a way that intervals between notifications gradually lengthen.

The system may also have an information processing method of administering email, which may include: storing an outgoing email repeat-notification schedule; administering outgoing email and the reception of reply-email with respect to the outgoing email; and repeatedly carrying out, in accordance with the repeat-notification schedule, transmission to outside terminals until a reply email to the outgoing email is received. Additionally, the repeat-notification schedule may be established in such a way that intervals between notifications gradually lengthen.

In accordance with different disclosed embodiments, the intervals between notifications in the repeat-notification schedule being gradually lengthened allows urgent notifications at the initial stage, and meanwhile, the intervals being extended along with the elapse of time keeps the number of email messages as a whole down to as few as feasible.

The embodiments disclosed herein make it possible to send multiple notifications, bring on a sense of urgency, do so efficiently, and also keep the number of emails down to as few as feasible, even when there is no reply for a long while.

Other embodiments disclosed herein relate to information-processing technology through which writing posted from a plurality of user terminals that are connected to one or a plurality of social networks are correlated with information-processing devices on the network(s).

Communication services executed via the Internet include bulletin boards, online chat, and blogs, and furthermore, SNSs in which these communication services are rendered possible at a system level. With SNSs, for example, posts (emails) of a variety of content from belonging members are made on the social network, with the posts being, as a general rule, browsable among the members. Accordingly, in terms of running the services, analysis and evaluation of the content of the posts are called for.

Japanese Unexamined Pat. App. Pub. No. 2007-323604 describes (Paragraph [0015]) a configuration for monitoring email, etc. on which evaluations are to be made with regard to users carrying out transactions in communities formed on the Internet, and in accordance with the evaluation results, issuing “warnings” to the users concerned. Japanese Unexamined Pat. App. Pub. No. 2008-181472 describes censoring libelous, slanderous or otherwise defamatory opinions/remarks from another member made about a website, particularly where the remarks are published on a LAN making it available to others while browsing. In such a case, informational censoring and complaint processes are carried out.

As for handling complaints, other than the foregoing, there is contacting, emailing, etc. of complaints (including negative messages) to business call centers and the like, while practical complaint handling, designed to have a customer service person deal with a given user, is also carried out.

In Japanese Unexamined Pat. App. Pub. No. 2007-323604, the “warnings” are matters that the system carries out based on evaluation results, not a matter of having a specified agent handle a complaint by associating it with a warning. And although Japanese Unexamined Pat. App. Pub. No. 2008-181472 has it that complaint processing is carried, nothing whatever with regard to specific methods is mentioned.

An illustrative embodiment may make available service-support servers, information processing methods, and information processing devices therefor that make it possible to responsively and effectively assign via a network a responsible staffer to posted writing, as well as to its source authority (user terminal), that from the results of searching on writing posted through SNSs and the like is to be watched.

A service-support server in an illustrative embodiment—in a service-support server for supporting the correlation of writing posted from a plurality of user terminals, connected to one or a plurality of social networks, with information-processing devices on the network(s)—is furnished with: a memory unit in which a plurality of modules that are downloaded to and executed in the information-processing devices is stored in advance; and a communications unit that receives requests from the information-processing devices, and that from the memory unit downloads to the information-processing devices modules corresponding to the requests. An embodiment is also characterized in that the memory unit stores a search module that executes a process of searching and retrieving posts from the writing, and an assign module that, in a state in which the retrieved posts are displayed in a first display area on an information-processing-device display unit, and at the same time information on each of a plurality of staffers registered in advance as assigned assisting personnel is displayed in a second display area on the information-processing-device display unit, receives an assign instruction for correlating information on any given staffer within the second display area with any given post within the first display, and assigns the correlation-social post to a communications terminal allocated to the correlation-scheduled staffer.

In an illustrative embodiment, by correlating writing posted through a social network(s) (SNS(s)) with information processing terminals allocated to correlation-scheduled staffers, enables, when the extracted post(s) is informative writing, contributing to desired effective uses such as publicizing by delivering the post in question online to another staffer(s).

Further, an embodiment may have an assign module receive the assign instruction and assign user terminals posting the correlation-social posts to the communications terminals allocated to the correlation-scheduled staffers. This makes possible the responsive and effective assigning via a network of a responsible staffer to the source authority (user terminal) of a posted writing that from the results of searching on writing posted through an SNS is to be watched.

In another embodiment, the search module may include an analysis module that, with regard to the retrieved posts, carries out an analysis in relation to importance level and establishes an identification marker corresponding to the importance level, and that the assign module corresponds the identification marker established by the analysis with the relevant post and display the post. Identification markers indicating importance level are thereby appended to the retrieved posts, therefore serving to allow improved visual checking with respect to importance level.

In yet another embodiment, the analysis module may include an importance-level-changing module that, on receiving an operation from the information processing devices, changes the importance level. This enables, by instructions to change the importance level, analysis that is versatile as well as more in conformance with reality.

In another embodiment, when importance level is changed by the importance-level-changing module, the analysis module feeds back the change result. This allows for a so-called learning function, the level of precision of the results of analyzing the importance level.

In another embodiment, the analysis module may be furnished with an influence-level discriminating module that distinguishes influence level with respect to either user terminals or posts, and that the assign module display indicators representing, in correspondence with the posts, how high the influence level is. This improves the checking of the influence level with regard to the writing.

Also, the assign module may contain, in the staffer information displayed in the second display area, attribute information on the staffers. By increasing the material for determining the assignments, to thus improve the suitability of the assigned staffers, this is more geared to service support. What is more, this can also serve in auto-selection of a staffer assignment.

In another embodiment, the assign module, when a source icon for a social network that is searched is selectively designated, may display only writing posted through the designated social network. This may allow for effective searching for posts within a desired scope on social networks. Additionally, configuring for social login facilitates the operation of designating a desired SNS.

An information processing device involving an illustrative embodiment—in an information processing device exploiting the results of searching on writing posted through a plurality of user terminals, connected to one or a plurality of social networks—is characterized in being furnished with: a display unit for displaying images; an assign-instructing unit for, in a state in which on a screen the results searching on the posts are displayed in a first display area and at the same time information on each of a plurality of staffers registered in advance as assigned assisting personnel is displayed in a second display area, instructing the correlating of information on any given staffer within the second display area with any given post within the first display; and an assign-setting unit for, on receiving the instruction, assigning the correlation-social posts to communications terminals allocated to correlation-scheduled staffers.

An information processing method involving an illustrative embodiment—in an information processing method by means of an information processing device exploiting the results of searching on writing posted through a plurality of user terminals, connected to one or a plurality of social networks—is characterized in being furnished with: an instructing operation of, in a state in which on a display-unit screen the results of searching on the posts are displayed in a first display area and at the same time information on each of a plurality of staffers registered in advance as assigned assisting personnel is displayed in a second display area, instructing the correlating of information on any given staffer within the second display area with any given post within the first display; and an assign-setting operation of, on receiving the assign instruction, assigning the correlation-social posts to communications terminals allocated to correlation-scheduled staffers.

This accordingly can contribute, when the extracted post(s) is informative writing, to desired effective uses such as publicizing by delivering the post(s) in question online to another staffer(s).

What is more, assigning the user terminals through which the correlation-social posts have been posted to the communications terminal that is allocated to the correlation-scheduled staffer enables supporting follow-up with the poster of the watch-out post.

Furthermore, with the information processing device being connected with a service-support server via a network, the required services are executed by downloading each of the modules for the processes.

In an illustrative embodiment, assigning writing posted through a social network(s) (SNS(s)) with information communications terminals allocated to correlation-scheduled staffers, enables, when the extracted post(s) is informative writing, contributing to desired effective uses such as publicizing by delivering the post(s) in question online to another staffer(s).

An illustrative embodiment also makes it possible responsively and effectively to assign via a network a responsible staffer to the source authority (user terminal) of posted writing that from the results of searching on writing posted through SNSs and the like is to be watched.

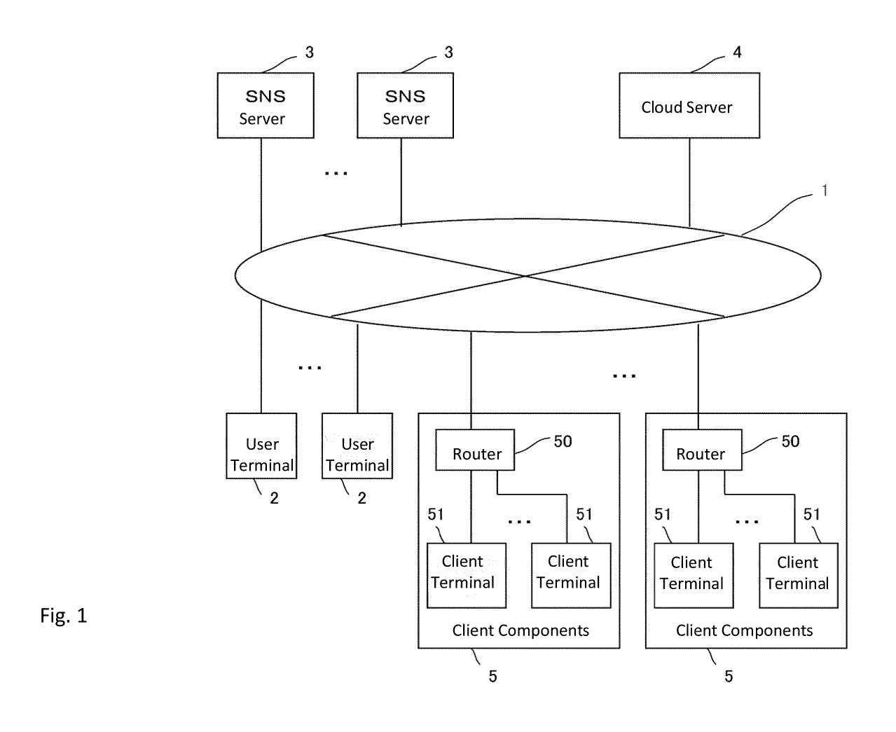

FIG. 1 is a diagram of an overall configuration representing a network system in accordance with an illustrative embodiment. In FIG. 1, the network system includes: a network 1 such as the Internet; a plurality of user terminals 2, 2, . . . connected to the network 1; various social networking service (or social networking site or SNS) server components 3, 3, . . . ; a cloud server component 4; and one or a plurality of client components 5, 5, . . . configured to link with the cloud server component 4.

The cloud server component 4 does not necessarily have to be a single machine, and, depending on needs, may be in a configuration in which it is arranged distributed over the network 1. For example, the database (storage) sections of the cloud server component 4 may be provided separately in different places. The client components 5 are, in general, assumed to be a terminal group (a plurality of terminals) connected to a company's or other enterprise's local-area network (LAN), for example. Thus, the client components 5 include a plurality of client terminals 51, 51, . . . . Control of communications paths for the plurality of client terminals 51 within the client components 5 is carried out via a router 50. Communications between the plurality of client terminals 51 and the network 1 is possible. Additionally, communications between the plurality of client terminals 51 and a different one of the plurality of client terminals 51 within the LAN are enabled. By way of the network 1, the client components 5 are able to communicate with the user terminals 2, 2, . . . , and they are able search for and browse data using websites, browsers, etc., which are omitted from the drawing. Furthermore, the client components 5 may download and execute later-described modules that are a variety of process programs, readied in the cloud server component 4. The client components may also save process content related to the process programs in a memory unit in the cloud server component 4. The process content can then be accessed or read from the memory unit in the cloud server component 4. Herein, a “module” refers to a program cluster for executing a given function. Also, further details of the cloud server component 4 and the client components 5 will be described later.

The user terminals 2 may be various devices in different embodiments. The user terminals 2 may be portable terminals (such as mobile telephone devices, PHS terminals, smartphones, PDAs, tablet terminals, etc.), or personal computers (PCs). The user terminals 2 are not limited by being or not being individually owned items. There may be instances in which the user terminals 2 are registered in the SNS server components 3, and there may be instances in which the user terminals 2 are not registered in the SNS server components. Not-registered user terminals 2, may be capable of posting (messaging) etc. to bulletin boards, online chat, and blogs, for example. A not-registered user terminal 2 may not be able to use email functionality, though. Since bulletin boards are as a general rule open to messaging and browsing, they make the provision and browsing of information on numerous unspecified persons possible. Online chats may display, on the user terminal 2's screens, text typed in real time between or among two or more members. This typed text represents conversational communicating in real time. Blogs and websites that are entirely administered within a specified domain, are diary-like websites where written compositions, impressions, etc. regarding various topics are arranged in a chronological series.

The SNS server components 3 are communication services that constitute websites allowing participation as members. Such participation may be conditional on introduction or the like by existing participants and on obeying operational rules. Such websites may allow members to message (post writings) and browse using email, bulletin boards, online chat, and blogs. Known SNSs include Facebook™, Twitter™, and YouTube™.

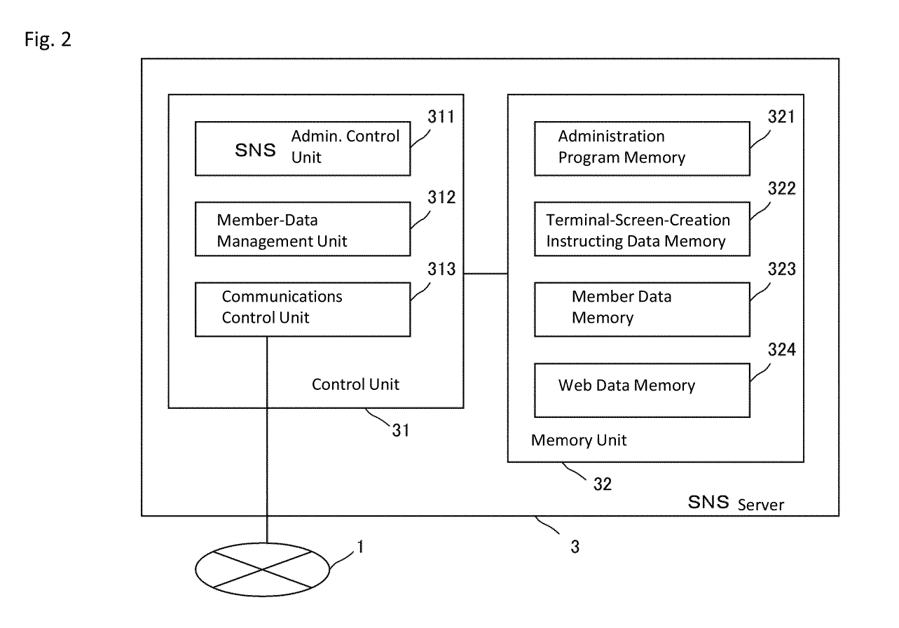

FIG. 2 is a block diagram representing an SNS server component 3 in accordance with an illustrative embodiment. In FIG. 2, the server component 3 is furnished with a computer, and has a control unit 31 made up of a central processing unit (CPU), and a memory unit 32, being storage in which various kinds of data are stored. The memory unit 32 includes: an administration program memory 321 in which various process programs for administering, etc. the SNS are stored; a terminal-screen-creation instructing data memory 322, in which screen data that is displayed on user terminals 2 and client terminals 51 that have logged in and data for instructing the terminals to create the screens is stored; a member data memory 323 in which data on SNS members is recorded; and a Web data memory 324 in which the content of each member's webpage on the SNS is stored and updated.

The control unit 31 reads programs out from the administration program memory 321 into a not-illustrated working memory (RAM: random-access memory) and executes the programs. By reading out the programs, the control unit 31 functions as: an SNS administration control unit 311 that executes/controls administration of the SNS, that is, the content of the various services described above; a member-data management unit 312 that manages various data on members; and a communications control unit 313 that carries out data communications through the network 1 among the user terminals 2, the client terminals 51, and the cloud server component 4 (all shown in FIG. 1).

The member-data management unit 312 carries out processes relating to the input of certain personal information. The personal information may include full name, nickname, sex, and date-of-birth, and further. The member-data management unit 312 receives the personal information, and processes the personal information into storage in the member data memory 323. The member-data management unit 312 may also carry out a process for the input or establishment of login IDs and passwords for members. This data may also be stored in the member data memory 323. The personal information, login IDs, passwords, and any other input data relating to a member is stored in the member data memory 323, and is stored to correspond with each particular member that the data is associated with.

The SNS administration control unit 311 controls a series of processes for the SNS. Such processes may include logging into and out of the SNS by the members of the SNS. Other processes may involve the member's activity while logged into the SNS. The user terminals 2 are furnished with Web browsers that enable browsing of webpages (data in Hyper Text Markup Language (HTML) format). For example, a member may attempt to access, from a certain user terminal 2, a uniform resource locator (URL) for the SNS. The URL may reference a location on or in the SNS server component 3. A process for logging into the SNS by a member may include sending in a user name, password, and a login ID to the SNS administration control unit 311. The member-data management unit 312 may make an authentication determination as to whether the member is valid. If the login is successful, the SNS administration control unit 311 transmits a member webpage to the given member's user terminal 2. The user terminal 2's display may receive and display the member webpages, etc. on a Web browser. The administration control unit 311, along with the communications control unit 313, may also execute email processes, online chat processes, and other processes (posting) according to content input from the members. The administration control unit 311 may also save into the Web data memory 324 posts that have been input. The SNS administration control unit 311 also reads out other members' posts into user terminals 2 and clients 51 that have logged in, allowing browsing.

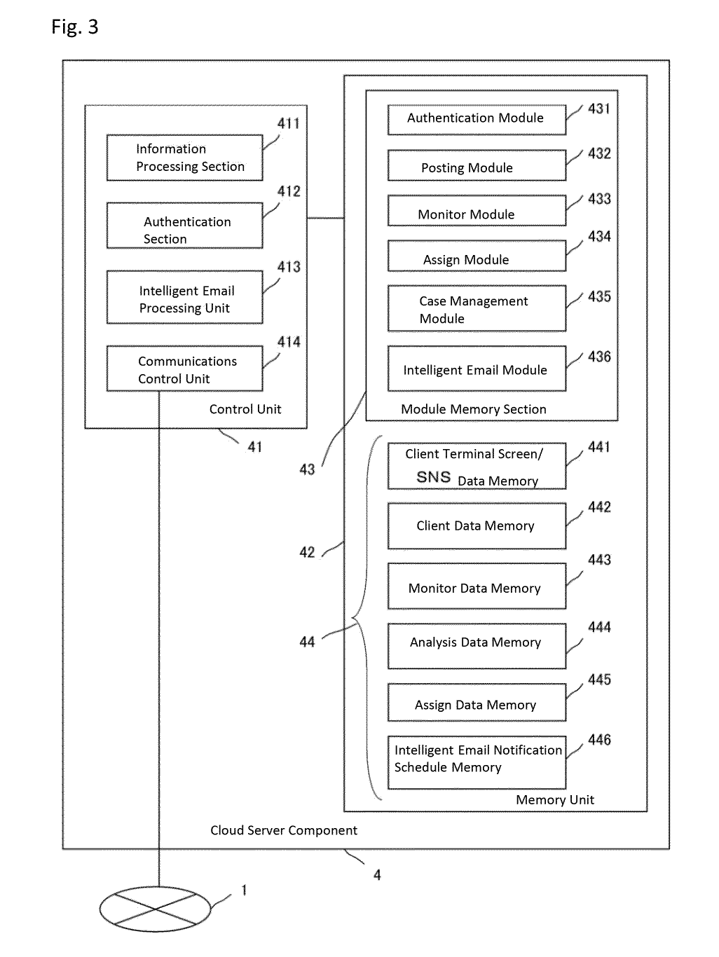

FIG. 3 is a block diagram representing a cloud server component 4 in accordance with an illustrative embodiment. In FIG. 3, the cloud server component 4 is furnished with a computer, and includes a control unit 41 made up of a CPU, and a memory unit 42. The memory unit 42 may be storage in which various kinds of data are stored. The memory unit 42 has a module-memory (functional-unit memory) section 43 for the respective functions, and a data memory section 44.

The control unit 41 functions as: an information processing section 411 that executes administrative and other predetermined information processes; an authentication section 412 that carries out authentication of client components 5 that have logged in by reading programs out from an authentication-module memory 431 in the module-memory section 43 into a not-illustrated work area (RAM: random-access memory) and executing the programs; an intelligent email processing unit 413 that executes a later-described intelligent email module; and a communications control unit 414 that carries out data communications through the network 1 among the client components 5, each SNS server component 3, and (according to need) the user terminals 2. It will be appreciated that the cloud server component 4 may adopt a configuration in which client terminals 51 in a logged-in state may communicate with, as members, user terminals 2 via the SNS server components 3. Further, the cloud server component 4 may enable direct communications between the client terminals 51 and the user terminals 2.

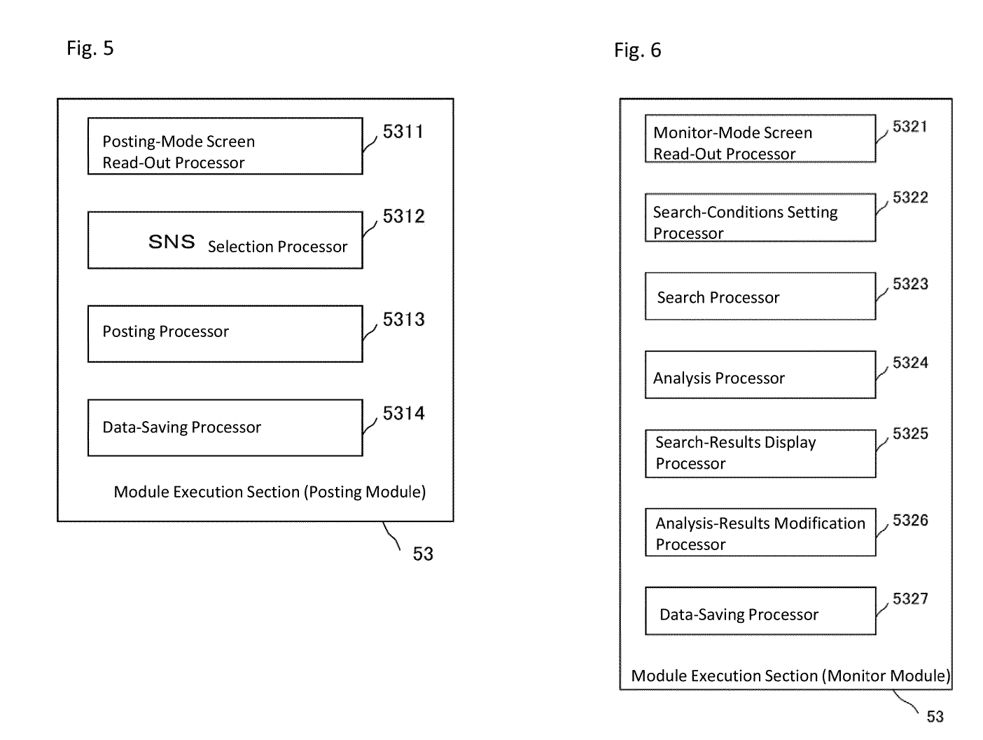

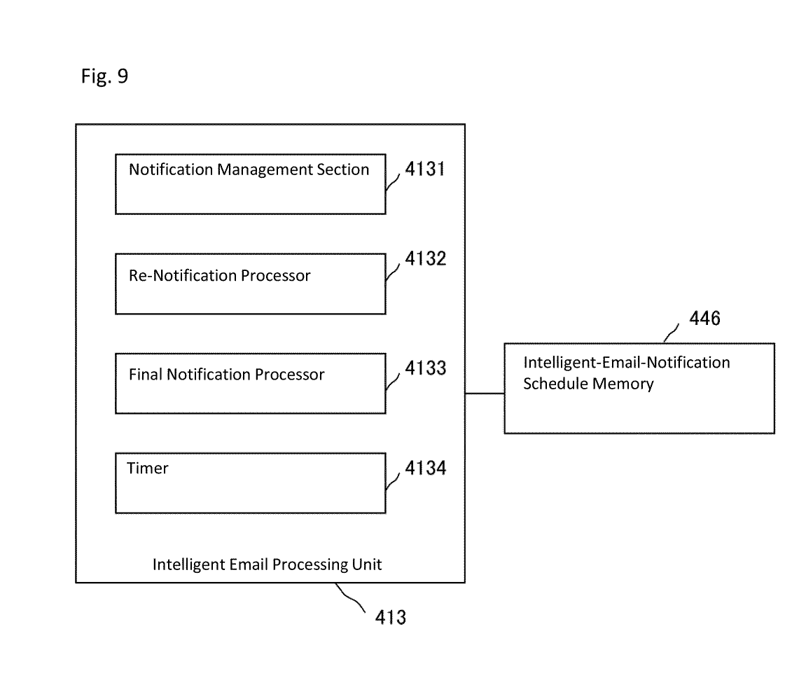

The module-memory section 43 has process programs (modules) for each function, and is furnished with: an authentication-module memory 431 for the executing of an authentication process; a posting-module memory 432 for the executing of a posting process; a monitor-module memory 433 for the executing of a monitor process; an assign-module memory 434 for the executing of an assign process; a case-management-module memory 435 for the executing of a case-management process; and an intelligent-email-module memory 436 for the executing of an intelligent email process. A detailed explanation of the process content of the posting-module memory 432 through the case-management-module memory 435 will be made below with respect to FIG. 5 through FIG. 8. A detailed explanation of the process content of the intelligent-email-module memory 436 will be made below with respect to FIG. 9.

The data memory section 44 is furnished with a client-terminal-screen/SNS data memory 441, a client data memory 442, a monitor data memory 443, an analysis-data memory 444, an assign-data memory 445, and an intelligent-email-notification schedule memory 446. The data memory section 44 and its various memory sections are assumed to have a large capacity. As a result, the data memory section 44 may be constituted by, ordinary memory, a hard-disk drive (HDD), or a solid-state drive (SDD). One, some, or all of those types of memory may constitute a database (storage). Further, in the memory unit 42, data may be saved and stored in order to enable access to the data by each client component 5.

The client-terminal-screen/SNS data memory 441 stores image and other data that may be displayed on the screens of the client terminals 51. The client-terminal-screen/SNS data memory 441 also stores data relating to SNS addresses that a particular client is a member of. Using the client-terminal-screen/SNS data memory 441, the cloud server component 4 knows which SNSs a client is a part of. It may be beneficial for the cloud server component 4 to register a client as a member of all available SNSs. As a result, the information processing section 411 can facilitate access (a so-called social login to) all the SNSs that a client is a member of. This may be accomplished through the client terminals 51 of the client components 5 by way of the cloud server component 4. A client may then be able to browse and monitor the webpages of other members or users on the SNS, make posts, and otherwise exchange email.

The client data memory 442 stores data relating to each client component 5 for which login has been permitted. If login has been permitted for a client component 5, the client component 5 may be designated as a member of the cloud server component 4. The data stored in the client data memory 442 may about each client component 5 may include data specifying client components 5, domain address data for connecting the cloud server component 4 with the each client component 5 to enable communications, and also password and login ID data for client authentication for each client component 5.

The monitor data memory 443 stores posted writings individually extracted with keyword searches by a later-described monitor module. These posted writings may be stored as corresponding with a particular client component 5. The monitor module may be executed on the client terminals 51 of any of the client components 5 or may be executed by the cloud server component 4. The posts may originate from the user terminals 2 by way of the user terminals interactions with the SNS server components 3. Further posts could originate from other client components 5. The analysis-data memory 444 is a dictionary-like analytical database that may be used for carrying out verbal analysis on text data in the posts or retrieved from the posts. This process of retrieving and analyzing post data is discussed along with the later-described monitor module.

The assign-data memory 445 stores results (the “assign” data) of assigning user terminals 2 and posts from the user terminals 2 to the appropriate parties. In this process, posted writings are watched or monitored. Posts that may merit a response or attention are assigned to a client terminal 51. Further, a post may be assigned to a client personnel (“staffer” hereinafter) for assisting the user who created the post. A staffer will be a person inside the client business entity running the client components 5. The staffer may be prepared or determined in advance as customer service persons, allowing the system to know who to direct a particular post to. The assign-data memory 445 will include this and other information and data on the staffers individually (staff data). The assign-data memory 445 also stores individual log information on emails or other communications exchanged as follow-ups between the respectively assigned staffers and users. This log information may also be utilized in a later-described case management process. It will be appreciated that the staffers may be limited to members belonging to an organization (customer service department) within the business entity, or may be individual personnel in, or the entire corporate staff of, a broader organization. Likewise, the assigning, as will be described later, may be carried out by the individual personnel in a marketing department within the business entity, or may be a selection process done automatically by a monitor results process. The intelligent-email-notification schedule memory 446, as will be described later, may send a schedule that determines dates and times for repeated transmission of a request email. The request email may be sent to a staffer multiple times according to the schedule staffer for requesting an assign, a reply email has not been sent back. Herein, request email may include short message service (SMS). The details will be described later.

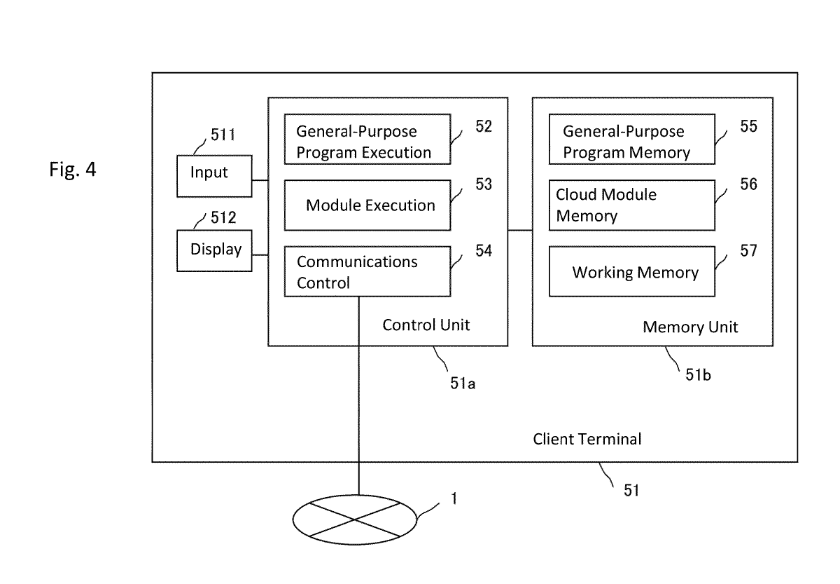

FIG. 4 is a block diagram representing one mode of embodying a client terminal 51 in a client component 5 in accordance with an illustrative embodiment. In FIG. 4, the client terminal 51 is furnished with a computer, and includes a control unit 51a made up of a CPU, and a memory unit 51b, being storage in which various kinds of data are stored. The client terminal 51 is further furnished with an input section 511 made up of a mouse and keyboard enabling input from without, and a display unit 512 which may include a liquid-crystal or plasma display on which in addition to displaying input data, data acquired externally is displayed.

The control unit 51a includes a general-purpose program execution section 52, which executes, by the CPU, general-purpose programs. This may not include programs that are cloud-module applications downloaded from the cloud server component 4, but may include application programs that are installed as general-purpose. The programs executed by the general-purpose program execution section 52 may also include document creation, image/video creation, sound creation, etc. for posting. The general-purpose program execution section 52 may also display images on the display unit 512. Further the control unit 51a includes a module execution section 53 that executes cloud-module programs that are downloaded to a later-described cloud module memory 56 after login to the cloud server component 4. The control unit 51a also includes a communications processing section 54 that communicates via the network 1 with the cloud server component 4 and the user terminals 2 etc., or even with not-illustrated websites and the like that are connected to the network 1.

The memory unit 51b includes: a general-purpose program memory 55 that stores various kinds of programs for text creation and image display in situations in which the client terminals 51 are used ordinarily, in a mode in which they are not logged in to the cloud server component 4; a cloud module memory 56 into which module programs from the cloud server component 4 are downloaded when the cloud server component 4 has been logged into; and a working memory 57 where, for example, data during the course of a process is saved momentarily.

FIG. 5 through FIG. 8 are block diagrams for explaining the process content of each of the modules that are stored in the module-memory section 43 in the cloud server component 4. Each of the blocks illustrated in FIG. 5 through FIG. 8 is executed in the module execution section 53 of the client terminals 5 in the client components 51, by being downloaded into the cloud module memory 56 in the client terminals 51. Accordingly, they will be explained in FIG. 5 through FIG. 8 as module processes in the state in which they have already been downloaded into a client 51.

FIG. 5 is a functional block diagram for an occasion when a posting module stored in a posting-module memory 432 in the cloud server component 4 is executed by a module-execution section 53 in the client terminal 51 in accordance with an illustrative embodiment. Posting is carried out in the client terminals 51. In particular, posting with respect to the SNS server components 3 is carried out by way of the cloud server component 4. Further, posting with respect to specified user terminals 2 is carried out via the SNS server components 3.

In FIG. 5, the module execution section 53, by executing a downloaded posting module in the CPU of the control unit 51a, functions as posting-mode screen read-out processor 5311, an SNS selection processor 5312, a posting processor 5313, and a data-saving processor 5314.

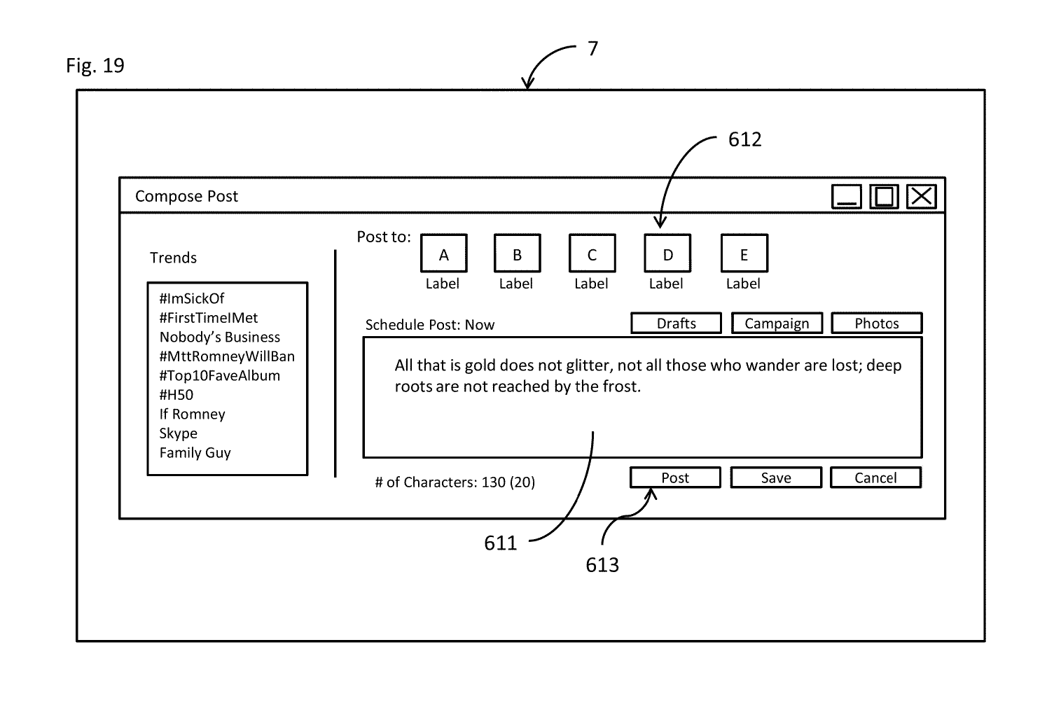

The posting-mode screen read-out processor 5311 carries out the displaying of a screen such as is depicted by screen 7 in FIG. 19, for example, on the display unit 512 of the client terminal 51.

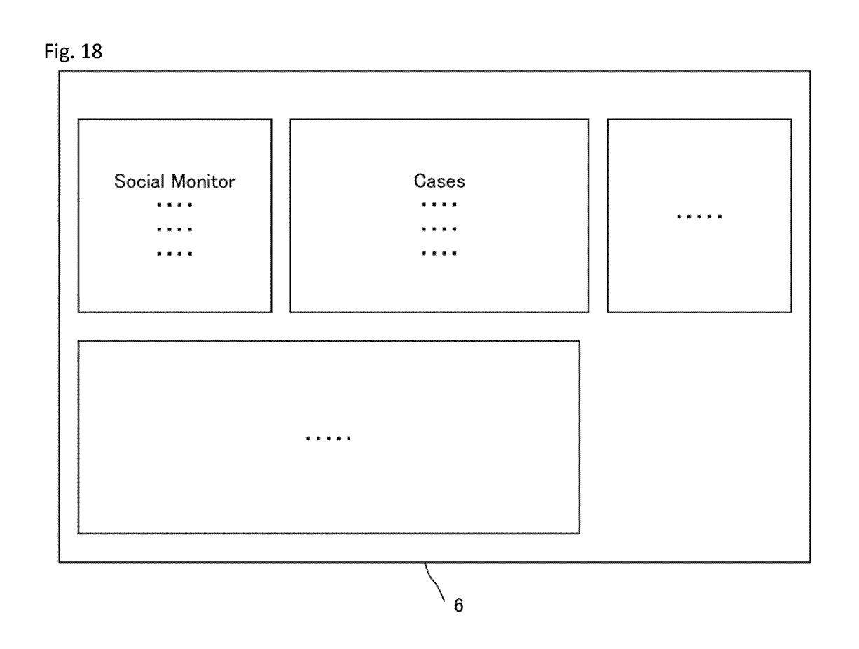

On a screen, for example screens 6-11 as shown in FIGS. 18-23, displayed on the display unit 512, a module selection screen 6 where radio buttons corresponding to each module are shown is displayed as a starting screen 6 (see, for example, FIG. 18). FIG. 18 is a diagram representing a starting screen 6 in accordance with an illustrative embodiment. These buttons may be shown, for example, after the cloud server component 4 has been logged into. It should be understood that in FIG. 18, radio buttons such as for instructing logout, for example, have been omitted. Then through using this starting screen 6 in FIG. 18 a next desired screen can be accessed. For example, screen 7 in FIG. 19, is one example of a subsequent screen in a case where a posting-module radio button has been selected.

FIG. 19 is a diagram representing an after-switching screen 7 in an instance where a posting-module radio button has been selected in accordance with an illustrative embodiment. By way of the example in FIG. 19, the posting module screen 7 includes a post input window 611 in roughly the screen middle, a post-destination list display area 612 in the screen upper end, and a process-radio-button display area 613 in the screen lower end. The post input window 611 is an area where posts created by operating the input section 511 are displayed. The post-destination list display area 612 is an area for designating post destinations. The post destinations include SNSs, etc. that the cloud server component 4 has registered as members in advance. That is, in a mode in which a system with the cloud server component 4 is being employed, each client terminal 51 in the client components 5 is connectable to the SNSs that the cloud server component 4 has registered, without a special operation such as logging into each SNS, etc. For example, the cloud server component 4 has social login functionality with respect to SNSs that are the objects of the registration. In other words, the system offers functionality allowing login with account addresses for the earlier-described SNSs that are social media. Accordingly, the cloud server component 4 executes an account setup process enabling login to the applicable SNS automatically in instances where a posting or like module is executed by the client terminals 51 in the client components 5 following a login to the cloud server component 4. Pressing down a chosen radio button among buttons (or icons) corresponding to each SNS in the post-destination list display area 612 sets it up so that the corresponding SNS is selected/designated, and a process whereby social login is conducted takes place.

Arranged in the process-radio-button display area 613 are, from the left-hand side, a post-instructing button for carrying out an instruction to post, a save button for carrying out an instruction to save written content to the cloud server component 4, and a cancel button for instructing the cancelation of posting and saving.

It will be appreciated that instructions with regard to the radio buttons displayed on the screen 7 in FIG. 19 can be carried out employing general operational methods. For example, a cursor image (not illustrated) movable within the screen 7 may be present, as well as a confirmation key for selecting something with a cursor image. Alternatively, the configuration may adopt a touchscreen construction (one example of embodying the input section 511), as is publicly known, with transparent pressure-sensitive circuit elements or the like stretching over the screen 7. In this embodiment, information is gathered from the sensed pressure-contact position and pre-established display coordinates for the radio buttons on the screen 7, in order to discriminate which of the buttons has been pressure-contacted. It will be appreciated that such embodiments may also be present with screens 6 and 8-11 as demonstrated by FIGS. 18 and 20-23.

The SNS selection processor 5312, on receiving operational content from the input section 511, carries out a process that selects a radio button indicating post destinations, displayed in the post-destination list display area 612. Alternatively, if no selection of destination is made, the post can be rendered on all of the available SNSs. In other words, all the SNSs may be selected by default when there is no selection made. In another embodiment, a default may be set to post to no SNSs when no selection is made. In yet another embodiment, the SNS selection processor may be have a default programmed mode of rendering a post to certain SNSs but not others. In this embodiment, there may be certain SNSs that are commonly selected for posting which would be included in the default setting.

The posting processor 5313, on receiving operational content from the input section 511, displays input text on the post input window 611. The posting processor 5313, on receiving the pressing down of the post-instructing button in the process-radio-button display area 613, carries out a posting process on the SNSs selection by the SNS selection processor 5312.

The data-saving processor 5314, on receiving an operation for the save button in the process-radio-button display area 613, writes SNS-selection content and posting content into the client data memory 442 in the cloud server component 4. In another embodiment, if the cancel button has been pressed, processes by the posting processor 5313 and the data-saving processor 5314 are cleared.

It will be appreciated that the “x” mark in the upper-right corner of the screen 7 in FIG. 19 is for instructing return from a current screen to a previous screen, or else to the starting screen 6 of FIG. 18.

FIG. 6 is a functional block diagram for an occasion when a monitor module stored in a monitor-module memory 433 in the cloud server component 4 is executed by a module-execution section 53 in a client terminal 51 in accordance with an illustrative embodiment. Here the monitor module searches, under predetermined conditions, writings posted through user terminals 2 that are members of the SNS server components 3. The monitor module further implements a predetermined analysis process and displays the results on the screen 7. This monitor process may be applied in a variety of uses. It may be used to monitor the societal reputation etc. of a company's own products and services. It may also find informative posts such as a complaint about a product that does not work properly and, e.g., circulate them within the relevant business unit.

In FIG. 6, the module execution section 53 uses a downloaded monitor module being executed in the CPU of the control unit 51a. Here, the module execution section 53 functions as: a monitor-mode screen read-out processor 5321; a search-conditions setting processor 5322; a search processor 5323; an analysis processor 5324; a search-results display processor 5325; an analysis-results modification processor 5326; and a data-saving processor 5327.

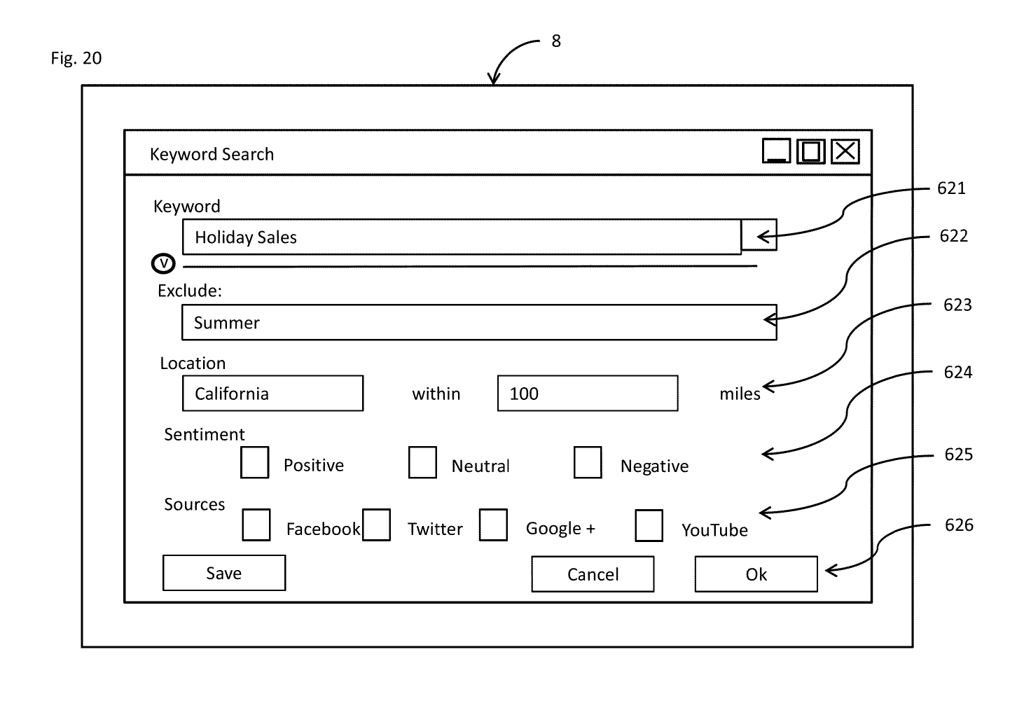

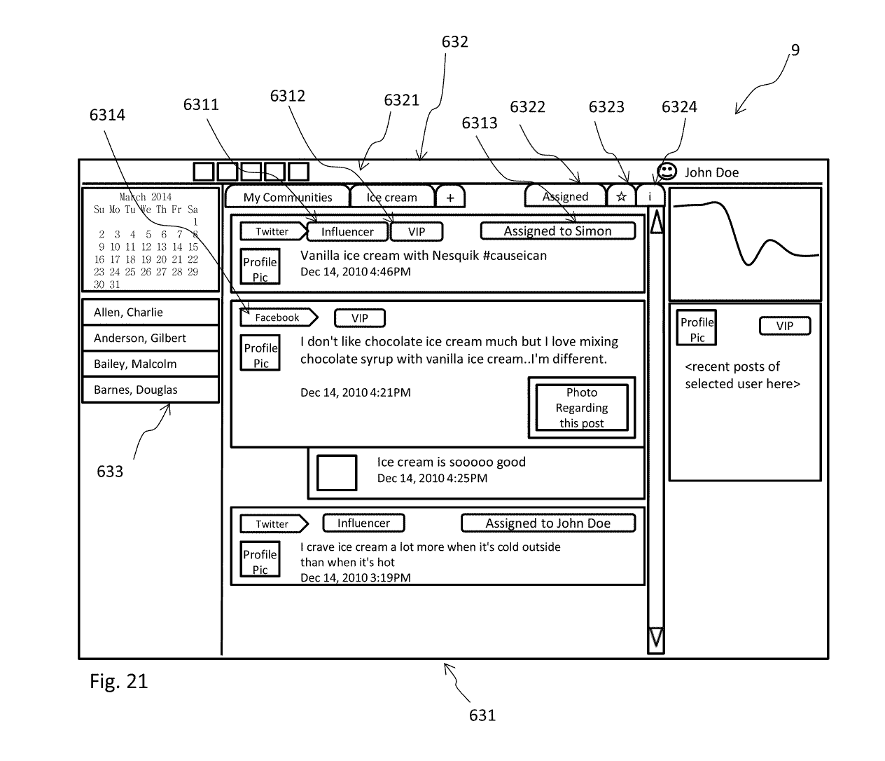

The monitor-mode screen read-out processor 5321 carries out, as one example, the display of a screen 8 such as depicted in FIG. 20 on the display unit 512 of the client terminals 51. In FIG. 20, the screen 8 presents one example of an after-switching screen in an instance where a monitor-module radio button has been selected through the starting screen 6 after login. Herein, following a search, the monitor-mode screen read-out processor 5321 carries out the display of a screen 9 such as depicted in FIG. 21.

FIG. 20 is a diagram representing an after-switching screen 8 in an instance where a monitor-module radio button has been selected through a starting screen 6 after login in accordance with an illustrative embodiment. In FIG. 20, arranged on the monitor-module screen 6 are, in order from the upper end, for example: a keyword input box 621; an exclusion parameters input box 622; a geographical parameters input boxes 623; a watch-out parameters setting row 624 for watch-out parameters (narrow-down parameters)—e.g., parameters relating to sentiment status—for the purpose of further selectively narrowing down; and a search-source selection row 625. In the lowermost portion, a process-radio-button display area 626 including a save button, a cancel button, a confirm button, etc. is provided. In the uppermost portion, an “x” button for returning from the monitor module to the previous screen or to the starting screen is displayed. In the keyword input box 621, “Holiday Sales,” for example, has been input as keywords. Alternatively, keywords relating to a company's own products and services that it offers may be input, so as to seek out what their latest evaluations and reputation on the social network are like. And the watch-out parameters setting row 624 categorizes instances for emotionally discriminating, for example, the content of posts, presenting a row with, e.g., the choices “Positive,” “Neutral” and “Negative.” Posted writing that has been retrieved according to keywords etc. is analyzed, as will be described later, by the analysis processor 5324.

The search-source selection row 625 is a screen for selecting a variety of registered SNSs for which the cloud server component 4 should enable social login. The SNS selection status may be rendered, for example, in a default mode where all registered SNSs are selected, or the default may be the opposite thereof. The scope of the search becomes the posted writings of the user terminals 2 that are members of the selected SNS(s).

The search-conditions setting processor 5322, on receiving operations through the input section 511, sets the conditions for searching on posted writing. Search conditions may include the earlier-mentioned keywords, exclusion parameters, geographical parameters, watch-out parameters (narrow-down parameters), and search sources. Herein, in addition to keywords, search sources may be adopted for the search conditions, and further, watch-out parameters (narrow-down parameters) may be employed. Search conditions other than those may be adopted in accordance with the preference of a client.

When the search conditions, etc., have been established and the Web browser has been launched, the search processor 5323 carries out a search process when an “OK” button within the process-radio-button display area 626 has been selected. The search process is basically the same sort of process as a general literature search and, for example, collates the search-condition terms against contributions posted via the SNSs, for identical terms therein, and extracts posts containing matching terms. Further, as far as geographical parameters adopted according to need are concerned, maps may be built into the processor and the system may determine whether a place name satisfies parameters within the maps.

The analysis processor 5324 executes a predetermined text analysis on the search results and the extracted posts, utilizing the analysis-data memory 444 database in the cloud server component 4. Here, a sentiment analysis is executed as one possible mode for the analysis process. In particular, the sentiments of users' learning including users' psychology, users' evaluations of a business and its reputation with them, and users' predilections can be learned in this manner by carrying out the analysis of sentiments from the user posts. This type of analysis may be helpful for the development of products and services. The sentiment analysis is executed in the following manner, as one example. The analysis-data memory 444 database has, in this implementation example, three sentence databases as examples of texts indicating emotional states, and one terminology score database. The emotional states are categorized into the three classes “positive,” “neutral” and “negative,” with the pertinence as well as the credibility indicated with a percentage % (“score” hereinafter). The aforementioned three sentence databases are where text examples pertaining to the earlier-described “positive,” “neutral” and “negative” are respectively categorized and stored, and the text examples include sentences as samples recorded in advance, and sentences as exemplars added to suit. The single terminology score database contains numerous terms (that it also contain idioms is may be helpful), and is set up by scoring each term with a pertinence, tag, rating, or similar identifier as to which of the three “positive,” “neutral” and “negative” classes the terminology pertains. In the case of the term “sweet,” for example, scores are established such that “positive” is 60%, “neutral” is 30% and “negative” is 10%; likewise, in the case of the term “stop,” for example, scores are established such that “positive” is 10%, “neutral” is 20% and “negative” is 70%. In the present embodying mode, the score settings basically are calculated depending on in which category of sentence database, among the “positive,” “neutral” and “negative” categories, text containing a given term is stored. For example, in the just-noted instance of “sweet,” supposing that altogether there are 10 sentences that contain “sweet” would mean that in the sentence database for the “positive” category, 6 sentences are present, in the sentence database for the “neutral” category, 3 sentences are, and in the sentence database for the “negative” category, 1 sentence is. Further improving the pertinence etc. of the sentences that are consulted is possible by addition and analyzing additional terminology that represent various sentiments. The present system utilizes the Internet or other network, and in situations where it is directed to users throughout the world, the sentences recorded in the databases and the language of the terms are not limited to English, and may include Japanese and furthermore may include the languages of other countries.

Thus the analysis process performs the extraction of terms from within each of the retrieved posts, and is carried out term by term. That is, with regard to each of the terms extracted from among the texts that are the analysis subjects, the scores for each of the categories “positive,” “neutral” and “negative” are mechanically tallied (summed) per category. As a result, the emotional state for the category in which the final cumulative value is greatest is set as the sentiment category to which a particular post or sentence pertains. In another embodiment, instead of, or in addition to, analyzing individual word units, the precision of the system may be raised further by adopting a method that employs scores on two-word strings for each respective category. For example, if there was a sentence containing “ . . . very sweet . . . ,” the analysis would be such as to take into consideration “sweet . . . ” and “very sweet.” Likewise, the number of categories for the analysis results is not limited to three classes; it may be that two categories indicate the presence/absence of applicability to the watch-out target “negative.” In yet another embodiment, the analysis process may include more than three categories. Also, for the analysis, instead of the method of the present embodying mode, other, publicly known methods can be adopted. The analysis may not limited to sentiments; depending on the monitoring objectives a variety of factors can be adopted.

The results from analyzing with the analysis processor 5324 are displayed on a screen such as screen 9 or screen 11 as watch-out content. To facilitate recognizing, according to presence/absence of pertinence, icons representing sentiment category, the display may be configured to exploit differences (including changes in color and brightness, changes in size, presence of flashing, etc.) in the display mode. Alternatively, taking into consideration whether the targets to be watched out for pertain to examples or comments of the sort that require user response—typically the “negative” category—the display may be configured to differentially indicate with icons whether or not the targets pertain to the “negative” category.

The search-results display processor 5325 enumerates, in chronological order, the posts that are the results of the search and displays them in a list.

The analysis-results modification processor 5326 may make it possible to modify the pertinence by the operator performing an operation instructing modification of the pertinence. For example, a modification may be used in situations where the operator of a client terminal 51 on reading a post has determined that the analysis result is not fitting. For example, the icon indicating sentiment category may be displayed as pertaining to a “negative” sentiment (or in other embodiments some other sentiment), and the operator of the client terminal 51 may believe the post should be categorized as pertaining to a different sentiment such as “neutral” or “positive.” The analysis-results modification processor 5326, for example, on receiving a selection in the display region where icons indicate the category, carries out a process of changing to the instructed category. Further, the analysis-results modification processor 5326 stores the post having the changed category as a watch-out-exemplar base in the sentence database for the changed category. The analysis-results modification processor 5326 may also execute a process of recalculating the score in the terminology score database for each term contained in the sentence in question. In this way, by referring to an analysis-results modification, a score relating to a sentiment for a modified term will conform more with reality. In other words, the system can learn to improve in accuracy every time the cloud server component 4 is launched.

FIG. 21 is a diagram representing a search results screen in accordance with an illustrative embodiment. In the screen 9 shown in FIG. 21, the mid-portion in the left-to-right orientation is a display window 631 for listing the retrieved posts top-to-bottom in chronological order. In the upper portion of the display window 631 a tab interface 632 is displayed. In the tab interface 632 is a keyword display tab 6321. Also shown in the tab interface 632 are explanatory legends, including an assignment-present/absent display tab 6322, a positivity display tab 6323, and a negativity display tab 6324. On the keyword display tab 6321, “Holiday Sales” corresponding to keyword used in the search represented in

FIG. 20 is displayed. In other embodiments, any number of keywords and tabs could be displayed in the tab interface 632. The word “Assigned” is shown on the assignment-present/absent display tab 6322. An icon whereby positivity is readily confirmed visually—here, a star-shaped icon—is shown on the positivity display tab 6323. That the post is positive is evident or identifiable because of the presence of the star-shaped icon. In another embodiment, if the post was not characterized as “positive,” the star-shaped icon may not be visible. In other embodiments, the tabs may indicate positivity or negativity through other methods. For example, a difference in coloration, such as being chromatic or achromatic, may indicate the presence/absence of a certain sentiment. On the negativity display tab 6324, an icon predetermined to leave the impression that it is to be watched out for—here, an exclamation mark—is shown. Again, the negativity may be identified, for example, by the presence/absence of the icon or a difference in coloration of the icon. In one embodiment, a chromatic star-shaped icon corresponds to “positive;” a chromatic exclamation-mark icon corresponds to “negative;” and situations when neither is applicable, where both the icons are achromatic, correspond to “neutral.” Similarly, if the “star” icon or the “!” icon are designated by the input section 511, the display color is inverted—that is, the pertinence is changed. This change is a process done by the analysis-results modification processor 5326 in the way discussed above. In other words, the operator may change the pertinence to a particular sentiment by inputting a selection of the positivity display tab 6323 or the negativity display tab 6324. In other embodiments, the positivity, negativity, or neutrality may be displayed in other ways. For example, there may be only one tab that indicates a sentiment. The tab may display a different icon depending on the applicable sentiment. Similarly, an operator may make a selection of the tab to change the sentiment.

In the display window 631 a plurality of posts are displayed in a vertical orientation. Instructing downward scrolling by means of an operation unit on the display unit 512 enables browsing of older posted items. With each post the user's image, a caption for the post, a name, the written body of the post, the posting time, etc. may be displayed. Also, within the display frame for each post, information corresponding to the above-noted explanatory legends may be displayed. For example, in the contribution at the uppermost tier, which is the recent-most post, by the “Watch Out” space an “!” icon is displayed in color. In the second post from the top, the “star” icon is displayed in color.

Also, in the post at the uppermost level, in the left-hand side of the first line, an “Influence” notation space 6311 and a “VIP” notation space 6312 are displayed in words. “Influence” is determined from the number of posts or the posting frequency, or otherwise, if need be, from the posted content etc., and indicates that the user has a high level of influence on other users. The “Influence” determinations are counts, frequencies, etc. and make a log of these informational items, and they are automatically sorted through names, email addresses, etc. and stored in a memory unit of the cloud server component 4—e.g., the analysis-data memory 444. “VIP” indicates that the user's level of impact on society is high. A “VIP” determination includes whether or not the person is a prominent public figure or celebrity. A “VIP” list of email addresses, names, etc. may be prepared in advance and may also be modified by suitable additions. Additions may be accomplished by collating retrieved email addresses, names, etc. with the “VIP” list, and may be stored in a memory unit of the cloud server component 4—e.g., the analysis-data memory 444. Alternatively, the configuration may be that an operator makes the determination and carries out an operation that confers a “VIP” icon.

Here, in the post at the uppermost level, in the right-hand side of the first line, for example, there is an “Assigned to Simon” notation space 6313. “Simon . . . ” is a staff person. Now while this display does not have a direct relationship to display of search results, it indicates that a user response by a staffer who has been assigned to a given user is underway. It will be understood that a staffer likewise has already been assigned to the fourth and sixth posts. The assign process will be described later.

Further, in a suitable place in the display box for each post, for example, at the left end of the first line, an icon 6314 indicating the authority, that is, the source, of the post appears. It will be understood that for the second post, it is Twitter™. In the FIG. 21 example, other posts, in addition to those posted by way of various types of SNSs, not posted by way of an SNS have also been retrieved. For example, a post not posted by way of an SNS may be an email to a customer service representative or department from a customer. In another example, a post not posted by way of an SNS may be a blog posting or other type of website on the internet that is not posted through an SNS. In this way, the monitor process may be in a mode in which the search is done limited to any SNS, or in a mode in which the scope of the search may not be limited to any particular SNS(s). The source SNS of a post may be visually confirmed readily with the appearance of the source icon 6314, and, thus, keeping track of the source icon for relevant posts has an advantage in that it eases shaping a response strategy against gossip and rumors, and prevents the operator from having to recall which SNSs were selected when performing a search for posts.

Here, at the left side of the screen 9 in FIG. 21, a staff-list display column 633 is shown. In a screen in which the search results alone are displayed, the staff-list display column 633 is not shown. That is, in a state in which transitioning to a later-described assign process has been instructed with respect to a search-results screen, a screen 9 such as in FIG. 21 is switched over to a different screen that may not show the staff-list display column 633. In this display example, the staffers are arranged with the head letter of their names in alphabetical order, and by scrolling through them, the name of a desired staffer can be shown in the staff-list display column 633. It will be appreciated that a configuration may be rendered in which the staff-list display column 633 is shown cooperatively with the search-results display screen 9.

The data-saving processor 5327 saves the content of FIG. 20 and FIG. 21 into the monitor data memory 443 of the cloud server component 4. In this way, by making temporary saving possible, the content can be read out and the process continued when desired, improving the operability.

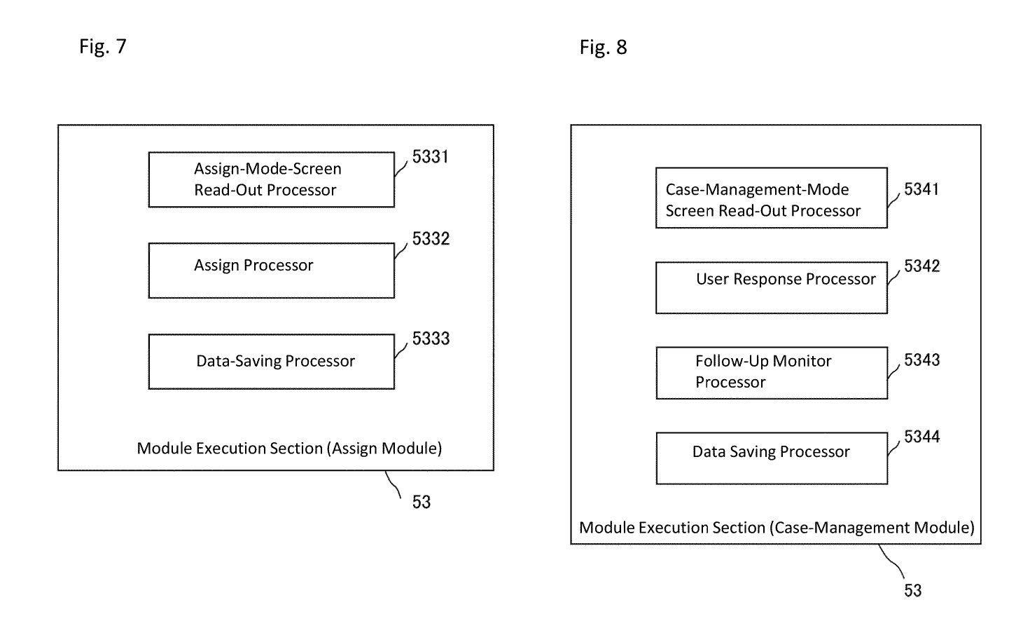

FIG. 7 is a functional block diagram for an occasion when an assign module stored in an assign-module memory in a cloud server component is executed by the module-execution unit 53 in the client terminal 51 in accordance with an illustrative embodiment. The assign module executes a process of linking (assigning) a user terminal through which retrieved posted writing has been posted, to a staffer's client terminal 51 in the client component 5.

The client terminals 51 within the client components 5 are allocated to personnel inside a business entity. Among them, staff of a predetermined department, e.g., a customer service department, are given roles as follow-up assistants for users. Alternatively, depending on the scale and specialty of the business entity, a plurality of units in the business entity, or otherwise nearly all the personnel, can be the organizational body that amounts to the staff. Such staff, as described above, may be assigned on the network to the user terminals 2 of posters of writing with high negativity. More specifically, the corporate entity providing the client components 5 carries out monitoring by, for example, the staff of its marketing department, and either manually or automatically allocates (assigns) a staffer from the customer service department etc. to the poster of the writing or the post itself. In such an embodiment, a writing posted from a user may pertain to the negativity category—a writing that should be watched out for. By assigning the post or poster to a staffer, a staffer may be able to follow through on the content of the post, solving mistaken understandings and getting a rethinking of faulty perceptions. In social-networking society, a single post has the potential to spoil good faith (mainly, in posts in which negativity is high). Often these posts may originate in a misunderstanding, etc. Such a post risks, despite the intentions of the poster, a drop in sales or inviting an irrecoverable loss of trust. Accordingly, discovering negative posts through the screen 9 in FIG. 21 as quickly as is feasible and following up swiftly can be important as a marketing strategy, especially with the sort of posts that may be based on mistaken understandings.

More particularly, an assign-mode-screen read-out processor 5331 presents a display such as the screen 9 shown in FIG. 21 when the assign module has been designated by following on the search results screen 9 and by search results momentarily saved in the monitor data memory 443 of the cloud server component 4 being read out from the cloud server component 4 by the assign module.

An assign processor 5332 carries out a process of assigning a member of a staff to a post to be watched. The assigning is performed by means of the input section 511, by correlating any staffer in the staff-list column 633 with the watch-out post display space. Herein, the “assign process” is a process in which a staff member of (assign official in) a marketing department internal to a client-component 5, while browsing FIG. 21, selects a single staffer from the staff-list column 633, and establishes a combination of the client terminal 51 that the staffer operates with the user terminal 2 (email address) of the user who contributed the post. An “assign complete” links the contributed post and email address of the user's terminal 2 to the staffer's client terminal 51, and sets the case management process as the target. The operations for the assign process may be carried out where, for example, the input section 511 is a mouse. A mouse may be placed such that a mouse pointer on the screen 9 is overlapping a box frame around the staffer. If a mouse button is depressed over the staffer, the staffer can be selected and dragged over the display space to the designated social post within the display window 631. Upon release of the mouse button, the staffer is then assigned to the designated social post.

When the operations for carrying out the assign—for example, the above-described drag-and-drop operations—are finished, the assign processor 5332, in response to the given process switches to a screen for drafting an email to the given staffer's client terminal 51 to request performing the assign. The system also carries out creation of the request email and executes its reporting, i.e., the process of transmitting it.

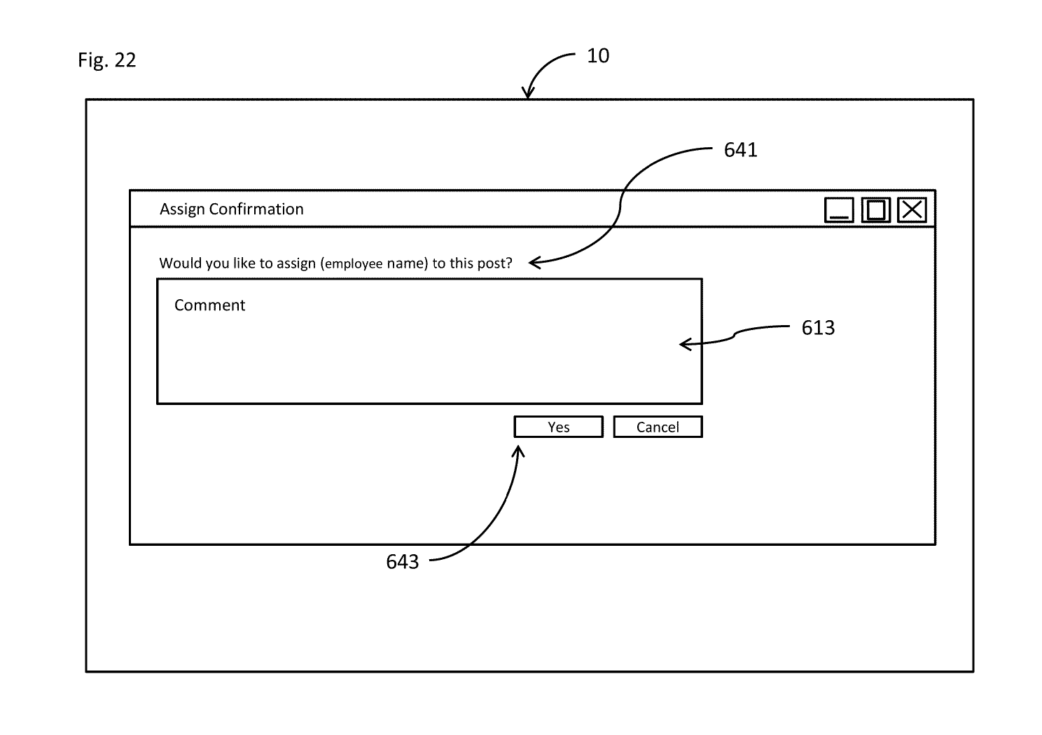

FIG. 22 is a diagram representing one example of an assign-request email drafting screen 10 in accordance with an illustrative embodiment. In FIG. 22, a sentence input space 641 for an assign-requesting sentence is shown. An example of an assign-requesting sentence is, “Would you like to assign [employee name] to this post?” In this case, the process is rendered so as to attach and transmit, as “this post,” data including email address for the user terminal 2 of the assign subject. Also, a comment-input box enabling comments to be added in as needed is provided. In the lower portion of the screen 10 an operation display region 643 is provided, and within it, an OK button indicating a notify instruction, and a cancel button that halts the notification appear.

A data-saving processor 5333 saves the associating content of the assign into the assign-data memory 445.

FIG. 8 is a functional block diagram for an occasion when a case-management module stored in a case-management-module memory in a cloud server component is executed by a module-execution 53 unit in a client terminal 51 in accordance with an illustrative embodiment. In FIG. 8, the module-execution unit 53, by executing a downloaded case-management module in the CPU of the control unit 51a, functions as a case-management-mode screen read-out processor 5341, a user response processor 5342, a follow-up monitor processor 5343, and a data saving processor 5344.

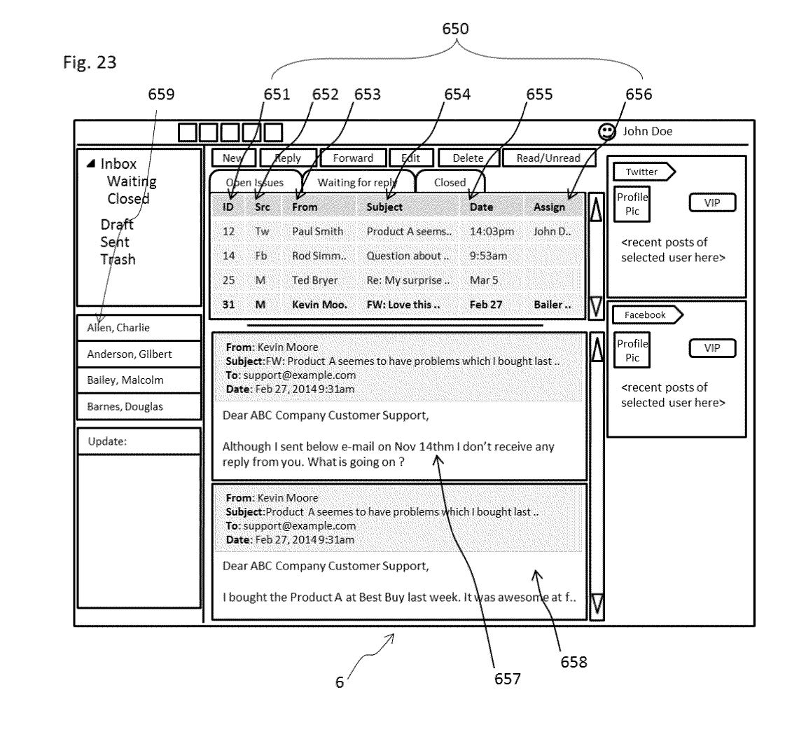

The case-management-mode screen read-out processor 5341 logs in to the cloud server component 4, displays a listing screen, such as presented in later-described FIG. 23 and screen 11, containing the staffers' names for each case that has been assigned. The listing screen may be displayed for particular cases where the case-management module has been designated. The display may be rendered by reading out the cases from the cloud server component 4 with the case-management module. Additionally, the listing screen display may incorporate scrolling, allowing a client to see and have access to more cases than may normally fit on one display screen.

The user response processor 5342 enables a list of electronic messages that have been assigned staffers, as shown on the screen 11 depicted in FIG. 23. In this embodiment, creating and sending of reply email as needed is possible. Additionally, executing other processes as user responses may be possible. In some embodiments, the possibility for creating and sending reply email as well as other responses may only be possible when a staffer's own cases have been selected.

The follow-up monitor processor 5343 supports monitoring or browsing of the follow-up status of cases for other persons apart from oneself, in order to grasp the progress of the cases. This feature can also be viewed on a screen such as screen 11 depicted in FIG. 23. In a similar embodiment, this may only be visible if cases for other persons apart from oneself have been selected. In another embodiment, the potential for this browsing and monitoring may enable a staff user to instruct staff changes and furthermore, follow-up reminders.

FIG. 23 is a diagram representing one example of a case-management mode screen 11 in accordance with an illustrative embodiment. In the FIG. 23 display example, an assign-completed list window 650 is displayed in the mid-portion in the left-to-right orientation of the screen 11. The assign-completed list window 650 is provided with an ID number display column 651, through to an assign-completed staff display column 656. The screen 11 also includes mail-log information 657 and email history information 658, which in this embodiment correspond to the first line of the assign-completed list window 650. The mail-log information 657 and email history information 658 are provided for the sake of follow-ups, and, in this embodiment, the case includes two messages in the email history information 658. Email for follow-ups, with links to corresponding case matters, is displayed in the manner of the mail-log information 657 and email history information 658, on receipt of a read-out instruction. Further, the mail-log information 657 and email history information 658 is not limited to the first line, and may be information with a log of case matters that the case-managing person has selected from what is displayed in the assign-completed list window 650. Herein, “the case-managing person” may be someone who has already been made full-time, or else a full-time person from the marketing department or customer-service department, someone charged with the duty, or otherwise any staff member.

The ID number display column 651 displays case-matter identification numbers. A source display column 652 displays the source of the post with the characteristic icon or logo. A user-name display column 653 displays the full name of the poster. A caption display column 654 displays a caption for the contributed post. A date display column 655 displays the posting date and time. The assign-completed staff display column 656 displays the names of staffers who have been assigned to given users. And by scrolling up and down through the display content using any known method, all of the assign statuses can be confirmed. A staff list window 659 is a list of the entire staff personnel. The staff list window 659 appearing jointly enables rotating or adjusting the assignment of staffers to particular cases. In this embodiment, a case that has become problematic may be reassigned to someone more senior or better equipped to deal with that case. The screen 11 provides all the information and capability to re-assign a case.

The data-saving processor 5344 is for saving the content of FIG. 23 into the assign-data memory 445 of the cloud server component 4.

FIG. 9 is a functional block diagram for an occasion when an intelligent-email module stored in an intelligent-email-module memory 436 in a cloud server component is executed by an intelligent-email processing unit 413 in accordance with an illustrative embodiment. The intelligent-email module includes a process of checking whether email in reply to the transmission of a request email by the assign processor 5332 has been received. When a staffer's client terminal 51 internal to a client component 5 is linked (assigned) to a user terminal 2, posted writing may be watched out for and retrieved by the monitor-module processes. A notification may be sent to the staffer prompting a reply to the post. If a post is retrieved and assigned, it should be replied to by the staffer. If a notification has not been replied to, the system may send a re-notification in cases where there has been no reply. More specifically, an initial request email for the purpose of an assign request is transmitted to the personal computer (PC) for an assign-scheduled staffer by the assign processor 5332. In some instances, the staffer handling the personal computer (PC) that is the send destination of this initial request email has swiftly performed a reply process. For example, a swift reply may occur when the staffer logs in the staffer's personal computer (PC) to the cloud server component 4 or otherwise opens the request email while logged-in and receives the request and replies to the request. The system may also send the reply by the data-saving processor 5333 to the assign-data memory 445 in the cloud server component 4. In the case of a swift reply, the repeat-notification process is not carried out and the present process concludes. On the other hand, if there has been no reply to the initial request email, then the present intelligent-email module is launched.

The intelligent email processing unit 413, by executing a program in the intelligent-email-module memory 436, functions as a notification management section 4131, a re-notification processor 4132, a final notification processor 4133, and a timer 4134.

The notification management section 4131 does not transition to the intelligent email process for cases where there has been a reply email in real time to the initial request email, but in cases apart from that carries out a process of launching the present intelligent-email module as a monitor subject. Also, when the notification management section 4131, regardless of the presence or absence of an assent to the assign-request email from the personal computer (PC) for the staffer that is the send destination, takes in that a reply email has been sent in return, it processes the email as there being a reply. Here, when a reply email has been received, return-transmission operation should be carried out to acknowledge the receipt of the reply email and cease the repeat-notification process. The return-transmission operation analyzes an email to determine whether it is a reply email that should terminate the repeat-notification process. In the case of a valid reply email, the client terminal 51 of the marketing department staffer to whom the original request for reply was sent should have sent the reply email. The return-transmission operation may also check whether the scheduled replier (the originally assigned staffer) is logged in to the cloud server component 4 to determine a valid reply email. The intelligent email processing unit 413 monitors for such return transmission of reply email. Furthermore, information with regard to the assign-request email and the scheduled requester should be stored, for example, in the assign-data memory 445, and at the point when the assign results have been concluded, a conclusion (or cancelation) process should be carried out.

The intelligent-email-notification schedule memory 446 is for storing a request-email transmission schedule when, as will be described later, the repeating (sending) of the assign request email is carried out. The intervals between transmissions in the request-email transmission schedule are lengthened little by little. For example: a time between an initial request-email transmission and a second request-email transmission is 1 hour; a time between a second request-email transmission and a third request-email transmission is 3 hours; a time between a third request-email transmission and a fourth request-email transmission is a half-day; a time between a fourth request-email transmission and a fifth request-email transmission is 2 days; and a time between a fifth request-email transmission and a sixth request-email transmission is 1 week. In situations where a head member or otherwise an official of the organization exists for the directed-to staffer, after an additional week, a final notification email is transmitted to the personal computer (PC) for the head member or official. By gradually lengthening the email transmission intervals in this way, the number of email messages as a whole can be lessened even while bringing on a sense of urgency. For example, if a request email is sent in a repeated cycle 1 hour at a time, someone may receive the same email 168 (=24×7) times in the course of a week. In the case of the present embodiment detailed above, a notification to a party on the above schedule would only cause 6 messages to be transmitted over the course of a week. The latter situation deters the risk of excess traffic over a network and a staffer accidentally deleting important email in a situation where someone is attempting to clear out an excess number of the repetitive (as in the example, 168 of such emails).

It will be appreciated that the notification management section 4131 may be configured for altering the email text in the request email for the initial time and thereafter. For example, in accordance with the transmission count, the morphology—e.g., the size, color, etc.—of the words may be modified so as to be more stimulating and to assist the staffer in responding timely and effectively, as well as assisting the staffer in comprehending the importance or urgency of a particular notification. Especially, in the request email ultimately to the head member or official, the transmission log information may be appended.

It should be noted that the request-email transmission schedule is not limited to one kind, and preferably is prepared to enable selecting a plurality of types depending on the status on the staff end, the status on the user end, and what the content of the post is like. For example, in the case of staffers, the number of currently assigned cases would be taken into consideration, and if the case number is large, the request-email schedule would tend toward the relatively extended. In the case of users, if the user is a famous person, someone whose posted case number is large, or a person with a high level of influence, the schedule would tend toward the relatively shortened. In the case of post content, if it commands a sense of urgency or is grave—for example, if within the post there are terms relating to time or terms like “rapid” or “serious” such as would suggest urgency or gravity—the schedule would tend toward the relatively shortened. “Tend toward the relatively shortened” includes carrying out the schedule at repetitions that, for example, with respect to the intervals in the earlier-described instance are each less than one multiple—e.g., at the ½ level or so—and in which the final notification email is quicker. Conversely, “tend toward the relatively extended” includes carrying out the schedule at repetitions that are each greater than one multiple—e.g., at the level of twice or so—and in which the final notification email is slower. Likewise, an embodiment may be such that the extending rate or shortening rate is different along the way—for example, for the second-time and thereafter request-email messages. In yet another embodiment, a particular schedule may be selected based on the type of electronic post, communication, or SNS the original post was on. For example, a chat room type communication may necessitate a quicker response from a staffer, and therefore an accelerated notification schedule may be used. In another example, a status update type posting may require a relatively less accelerated notification schedule. In SNSs that allow a staffer to see when a poster was last active, or allows a staffer to see when a poster is logged in, a post may be assigned a different notification schedule based on that information. Regardless of whatever schedule is adopted, an embodiment may be such that the assign manager issuing the initial request email sets the schedule, or the notification management section 4131 determines the aforementioned statuses of the staff, users, and post content, and automatically sets the schedule from among a plurality of available schedules.

The re-notification processor 4132 is for executing a process of transmitting the second-time and thereafter request emails when there has not been a return transmission of an email in reply to a first-time request email. The final notification processor 4133 is for executing a process of transmitting a final request email when there has not been a return transmission of an email in reply to multiple-time request emails, such that it is the last time.

The timer 4134 is in order to detect transmission date/time for the second time and thereafter. In particular, from clocking information in the timer 4134, and from the marked time of the first-time request email and the content of the intelligent-email notification schedule, the re-notification processor 4132 determines whether or not the transmission time for the second-time or thereafter request-email transmission has been reached, and if so, the re-notification processor 4132 executes the transmission process. From clocking information in the timer 4134, and from the marked time of the first-time (or one-time prior to the final) request email and the content of the intelligent-email notification schedule, the final notification processor 4133 determines whether it is time for the final request-email transmission, and if so, the final notification processor 4133 executes the transmission process. For example, supposing that the initial request-email transmission was at 9:30 a.m. on the present day, then once an hour of time has elapsed such that the time reaches 10:30 a.m., the re-notification processor 4132 determines that the marked time for the second-time transmission has been matched, and executes the second-time transmission process.

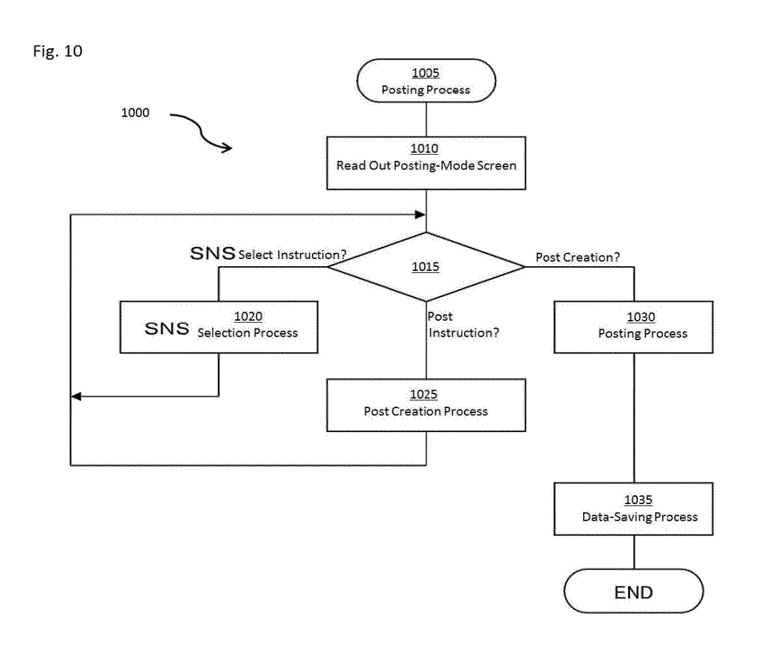

FIG. 10 through FIG. 15 are flowcharts for illustratively explaining single modes of embodying procedural steps in each of the modules read out from the cloud server component 4 and executed by a control unit (CPU) in the client terminals 51.

FIG. 10 is a flowchart 1000 representing a procedure for a posting process 1005 in accordance with an illustrative embodiment. In FIG. 10, to begin with, there is a login request to the cloud server component 4 from a client terminal 51, and once a predetermined authentication process has been gone through and the login recognized, a starting screen 6 (FIG. 18) is displayed, and when a posting-module execution radio button in the display screen 6 is pressed down, the posting-mode screen 7 depicted in FIG. 19 is displayed on the display face of the client terminal 51 (read out posting-mode screen 1010).

Subsequently, with the posting-mode screen 7 it is determined whether there is an SNS selection instruction, whether there is creation of new post text, or whether there is a posting instruction in element 1015. In general, the SNS selection instruction and creation of new post text are carried out to begin with. Then in the case of the SNS selection instruction, the selected SNS is set (social login) as the destination address for the post (SNS selection process 1020). Next, a social media post creation process is executed (post creation process 1025). In the case of the SNS having been selected (or it may be as selected by default) and the writing to be posted having been created, the presence/absence of a posting instruction is determined. In the case of the posting instruction, a posting process is executed (posting process 1030). When the writing is posted, fresh publicity or advertising by a client corporate entity is assumed. Subsequently, the posted writing and the posting destination (SNS) are stored in a data area by the given client component for the cloud server component 4 (data-saving process 1035).

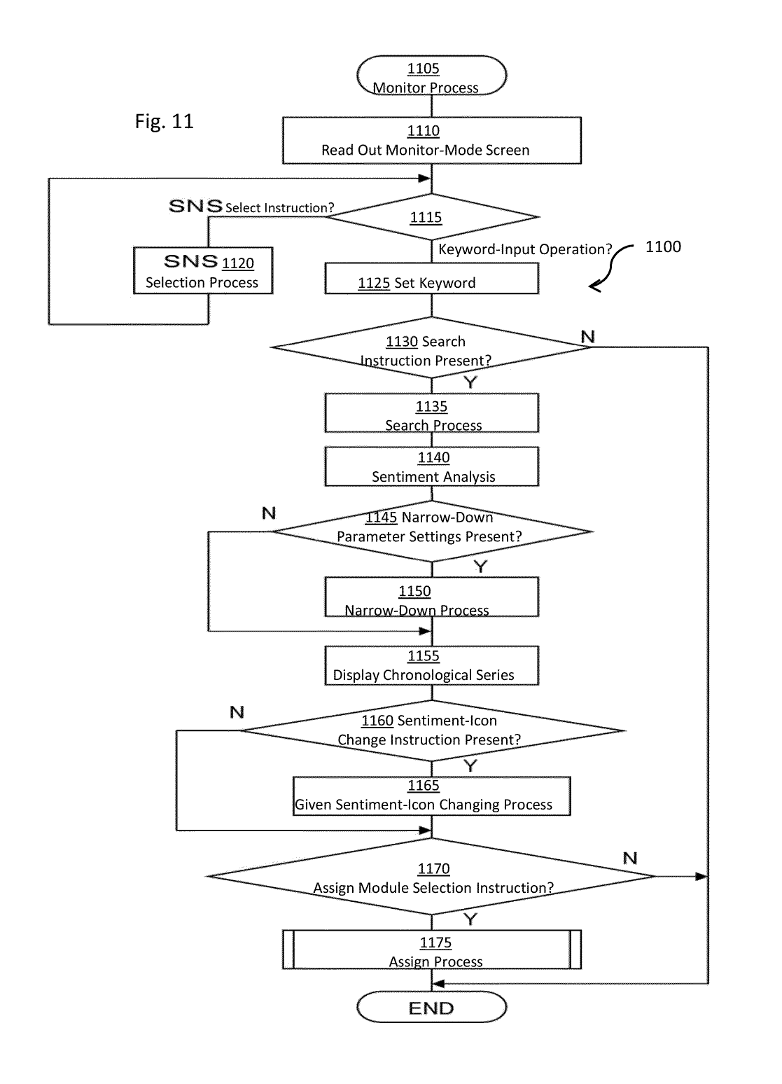

FIG. 11 is a flowchart 1100 representing a procedure for a monitor process 1105 in accordance with an illustrative embodiment. In FIG. 11, there is a login request to the cloud server component 4 from a client terminal 51. Once a predetermined authentication process has been completed and the login recognized, a starting screen 6 (FIG. 18) is displayed. If a monitor-module execution radio button in the display screen 6 is pressed down, the monitor-mode screen 8, depicted in FIG. 20, for the inputting of search parameters is displayed on the display face of the client terminal 51 (read out monitor-mode screen 1110).

Subsequently, with the monitor-mode screen 8, it is determined whether there is an SNS selection instruction, and whether there is a keyword-input operation (element 1115). In the case of an SNS selection instruction, the instructed SNS is selectively set as the monitor subject (SNS selection process 1120). And in the case of a keyword-input operation, the keywords are input into the keyword input box 621 (set keyword 1125).

Continuing, the presence/absence of a search instruction is determined (search instruction present? 1130), and when the OK button 626 is pressed down, the search process is executed (search process 1135). If there is no search instruction, then for example after the elapse of a certain time period, or if a (not illustrated) cancel operation has been undergone, the present process flow is exited (END). The search process is for searching and extracting, within the scope of the selected SNS, posts containing keywords. The earlier-described analysis process is conducted on each of the extracted posts (sentiment analysis 1140). Subsequently, it is determined whether or not the extracted post is to be narrowed down further (narrow-down parameter settings present? 1145), and if it is to be narrowed down, a narrow-down process is executed (narrow-down process 1150); if that is not the case, then the process is skipped and the flow proceeds to display chronological series 1155. It should be understood that an embodiment may be such as to enable the narrowing-down to be carried out prior to search process 1135 (for example, when the keywords are set in set keyword 1125). In display chronological series 1155, the extracted posts are displayed in chronological series in a predetermined orientation—herein, vertically, as depicted in FIG. 21.

Continuing, the presence/absence of an instruction to modify the positivity display tab 6323 or the negativity display tab 6324 is determined (sentiment-icon change instruction present? 1160). If there is an instruction to modify at least one of either the positivity display tab 6323 or the negativity display tab 6324, the display state is inverted, for example, being changed in alternation from “pertinence present” to “pertinence absent” or to “neutral,” or otherwise the opposite thereof (given the sentiment-icon changing process 1165). Herein, switching the “star” icon on/off, or the “!” icon on/off makes it possible to instruct the modification. For example, if a “star” icon in an “on” (chromatic) state is made “off” (achromatic), and an “!” icon in the “off” state made “on,” then for a given post the sentiment analysis results are changed from “positive” to “negative.” If there is no modification instruction, the sentiment-icon changing process 1165 is skipped.

It should be noted that in instances of the just-described modification process, when a given monitor mode is momentarily ended and the data is reflected in the analysis-data memory 444 of the cloud server component 4, as explained earlier, the given post is added by the information processor 411, and a recalculation of the score for the terminology within the terminology score database is executed. The terminology score database in the cloud server component 4 is thereby updated every time an updated post score is added, serving to improve the analytical precision.

Continuing, it is determined whether selection of the assign module has been instructed (assign module selection instruction? 1170), and if it has not been instructed, then the present process flow is exited. If it has been instructed, then the flow transitions to the assign-module process (assign process 1175).

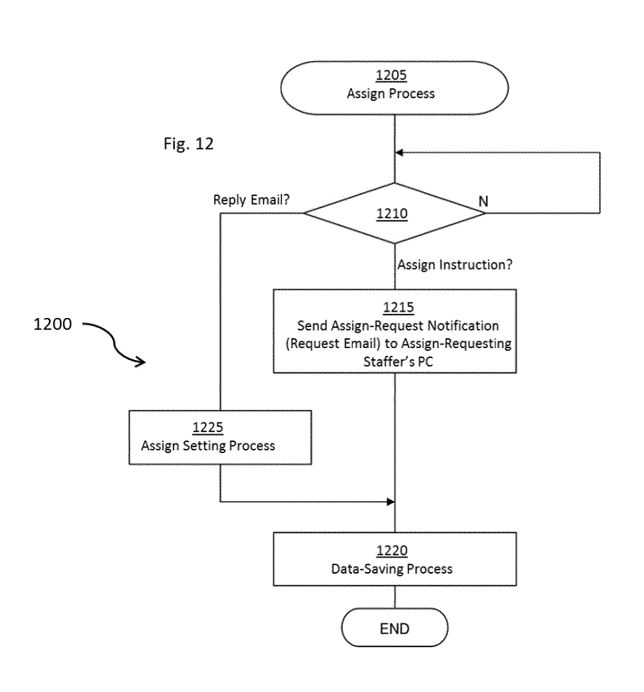

FIG. 12 is a flowchart 1200 representing a procedure for an assign process 1205 in accordance with an illustrative embodiment. To begin with, a screen 10 as seen in FIG. 22 for making an assign to a staffer is displayed, and subsequently, it is determined whether there is an assign-setting operation (element 1210). If there is an assign-setting operation, the assign process—namely, at first transmission of a request email—is executed (send assign-request notification (request email) to assign-requesting staffer's PC 1215), and further, the purport of the email is saved in the assign-data memory 445 in the cloud server component 4 (data-saving process 1220). In element 1210, if an email in reply to the request email comes in during the assign-module process, an assign-setting process 1225 (with or without assent) is carried out, and the purport of that email—that is, information that is apart from the object of intelligent email—is saved in the assign-data memory 445 in the cloud server component 4 (data saving process 1220). Instances where a reply email has not been received during the assign process would be the objects of intelligent email. Furthermore, in cases where there is no assent, another staffer should be appropriately put into the settings.

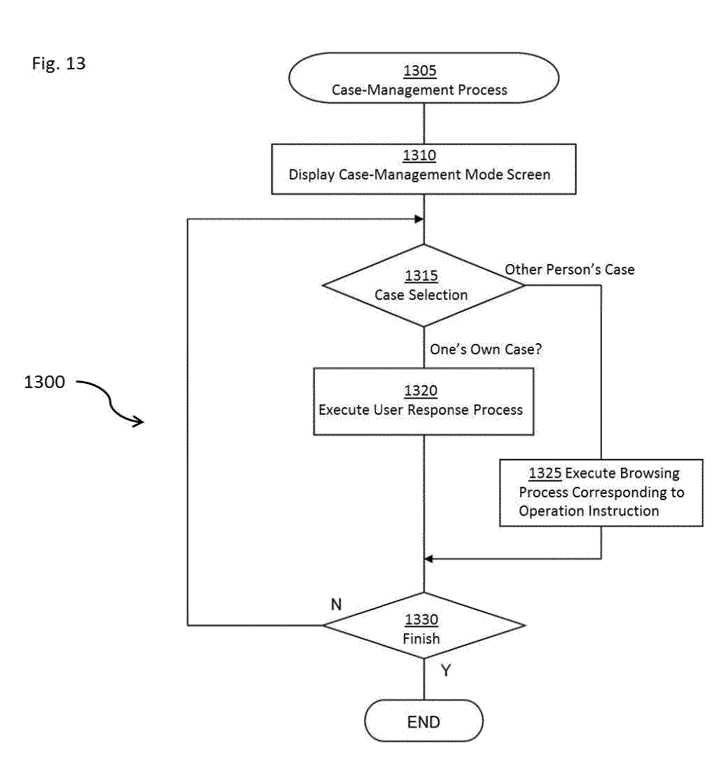

FIG. 13 is a flowchart 1300 for representing procedural steps in a case-management process 1305 in accordance with an illustrative embodiment. The case-management process is a process used to confirm staff follow-up with respect to a user. When the case-management process is selected after login, the screen 11 depicted in FIG. 23 is displayed (display case-management mode screen 1310). Subsequently, it is determined whether a desired case has been selected from within the assign-completed list window 650 (case selection 1315). Here, if on the screen 11 depicted in FIG. 23 listing assigned staffers, one's own case has been selected, the list of emails with assign-completed users that have been linked to one's own case is displayed as a log. Additionally, as needed, reply email is created and sent, or other processes that qualify as user responses are executed (execute user response process 1320). On the other hand, the process is designed so as, in situations where cases for other persons apart from oneself have been selected, to support monitoring and browsing their follow-up status and carrying out the instructing, etc. of staff changes and follow-up reminders, and grasping the progress (execute browsing process corresponding to operation instruction 1325).

Subsequently, if finishing (finish 1330) is instructed, the present process flow ends, and if that is not the case, the flow returns to case selection 1315. Alternatively, if finish 1330 is reached, the system may transition from the case-management process to another process.

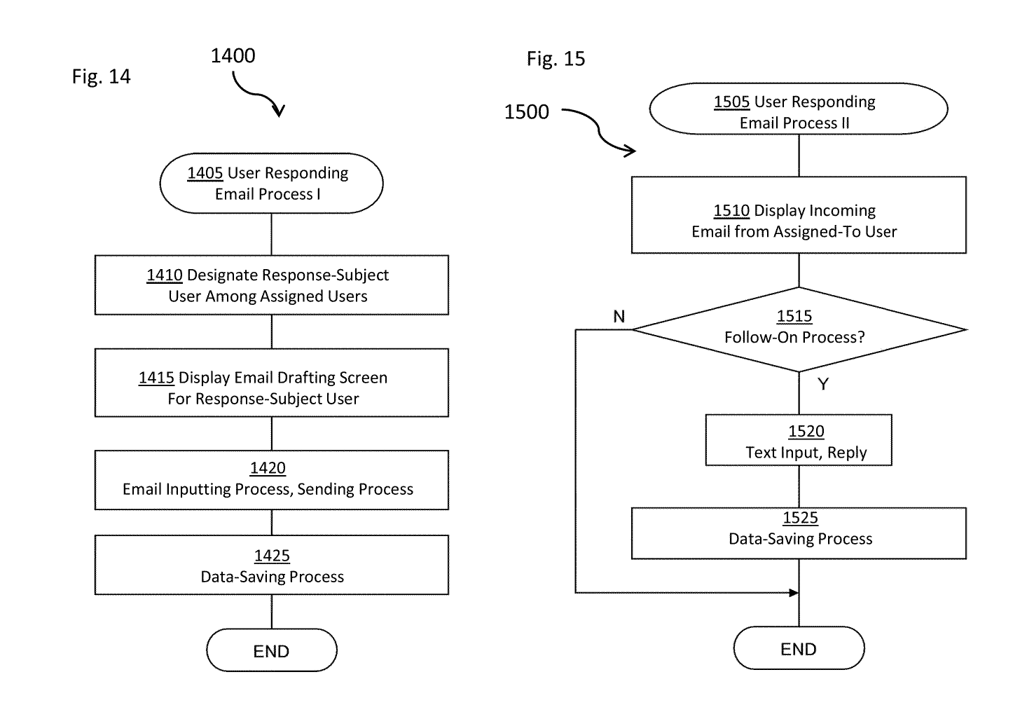

FIG. 14 is a flowchart 1400 representing a procedure for a User-Response Emailing Process 11405, executed upon a send destination being designated in a posting process in accordance with an illustrative embodiment. This process represents one mode to execute user response process 1320 in FIG. 13. User-Response Emailing Process I is executed utilizing log content in the client data memory 442.

To begin with, the case-management module is selected from the cloud server component 4, and among the assigned users, users who are the subjects of follow-up are designated (designate response-subject user among assigned users 1410). Subsequently, a screen for email to the users that are follow-up subjects is displayed (display email drafting screen for response-subject user 1415). A text input process is executed in accordance with a word input operation etc. on the screen by a staffer for the sake of user response (follow-up), and further, on receiving a transmission instruction a send process is executed (email inputting process, sending process 1420). The inputted user response text and a transmission log therefor are updated and saved in the assign-data memory 445 in correspondence with the given staffer (data-saving process 1425).

FIG. 15 is a flowchart 1500 representing a procedure for a User-Response Emailing Process II 1505, executed in a posting process in accordance with an illustrative embodiment. Follow-up Process II is a process carried out after an initial user-reply email has been sent to a user to whom a staffer has been assigned. In more detail, the staffer's client terminal 51 is logged in to the cloud server component 4, and by the given staffer's incoming email log (FIG. 23 reference) being opened, the present process flow is begun. Then, with there being incoming email from the assigned-to user, by opening it, the email from the user is displayed on the screen (display incoming email from assigned-to user 1510). Subsequently, a determination for a follow-on process of whether to reply again is made (follow-on process? 1515), and in the case of no follow-on, the present process flow is exited. On the other hand, in the case of the follow-on process, the transmission mode is switched into, and text in response to an operation of inputting follow-on sentences is inputted, and a send instruction is then transmitted to the given user (text input, reply 1520). The inputted user text and the messages sent back in response thereto are then updated and saved as a log in the in the assign-data memory 445 in correspondence with the given staffer (data-saving process 1525).

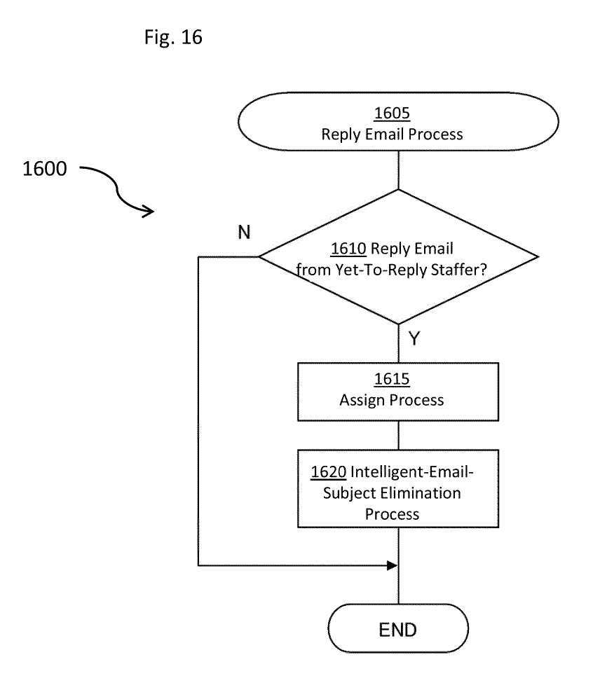

FIG. 16 is a flowchart 1600 representing a reply email process 1605, executed by an intelligent-email processing unit 413, for when email replying to a request email for an assign has been received in accordance with an illustrative embodiment.

At first, after an initial request email for an assign has been sent to the assign-scheduled staffer, it is determined (reply email from yet-to-reply staffer? 1610) whether there is a reply email from the staffer (yet-to-reply staffer). If there is no reply email from the yet-to-reply staffer, then the present process flow is exited. Meanwhile, if there is a reply email from the yet-to-reply staffer, then the assign process is executed (assign process 1615). The “assign process” includes both cases where a request email is assented to, and cases where it is refused. That is because in either case, a result in response to the assign-request email is obtained. Subsequently, an intelligent-email-subject elimination process is executed (intelligent-email-subject elimination process 1620)—that is, deletion from the assign-data memory 445 eliminates from the subject of the intelligent email process in regard to a given case.

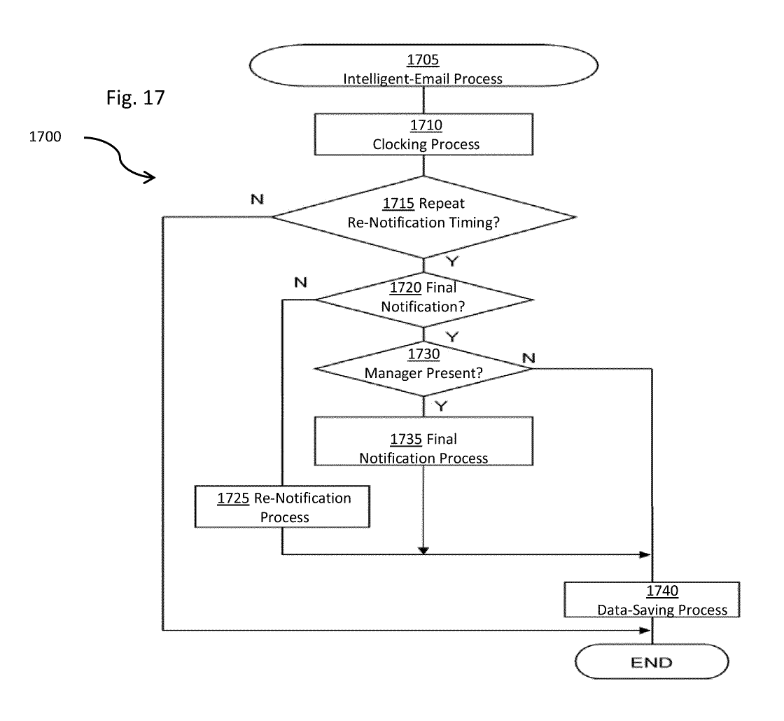

FIG. 17 is a flowchart 1700 representing a procedure for an intelligent-email process 1705 executed by an intelligent-email processing unit 413 in accordance with an illustrative embodiment. It should be understood that while this process is carried out directed to all staff members who have not sent back a reply email to an assign-request email, in the following explanation, for the sake of convenience, a single staffer is described as the target person.

At first a clocking process (clocking process 1710) at standard time intervals—e.g., one-second (which may be, alternatively, one-minute, etc.) units or the like—is executed by the timer 4134, and a determination is made as to whether the current time has matched a repeat re-notification timing that has been set for the staffer who is the target (repeat re-notification timing? 1715). That is, a next repeat re-notification may only be sent if the given staffer's schedule indicates that the staffer will be available. In this case, the schedule memory 446 is compared to the time-marking information in the timer 4134. If it is not the time to send a repeat re-notification, the present process flow is exited and another determination at the next timing for a repeat re-notification is made.

On the other hand, in the case where it is the timing for the repeat re-notification, whether or not the timing is for a final notification is determined from the schedule (final notification? 1720). If it is not a final notification, an instruction to re-notify of the request email is received and the re-notification process is executed (re-notification process 1725), and further, the current-instance re-notification process is saved as a log in the intelligent-email-notification schedule memory 446 (data saving process 1740), and the present process flow is exited. Meanwhile, if it is a final notification, whether a manager is present—that is, whether a manager has been put into the settings—is determined (manager present? 1730), and if one has been put into the settings, final notification to the client terminal 51 for the given manager is carried out (final notification process 1735). Then after the final notification process, the log is saved in the intelligent-email-notification schedule memory 446 (data-saving process 1740). On the other hand, in situations where a manager has not been included in the settings, the final notification is not carried out. It should be noted that where a manager notification is not in the settings for sending a last re-notification email, the last email sent to the originally assigned staffer should be sent with added features to draw attention to the message. For example, the message may be sent with the color, the size of the letters, etc. in the display appearance altered for ease of visual confirmation to call attention to the fact that it is a final re-notification email.

It should be understood that the following configurations, modes, and embodiments can be adopted for the embodiments disclosed herein:

(1) Selection of a staffer to whom there will be an assign may be done in the following manner. For example, suitability of a staffer to reply to a message is considered, including how packed a staffer's schedule is. Suitability information may also consider a staffer's experience as well as fields of specialty, differences between staffers (age, gender, others), the attributes of the complainant, and influence or urgency (degree of impact) of the post. In other words, the assignment may be done in such a way that selection of a staffer is made taking into consideration user attributes (age, gender, others), complaint content (size, urgency), etc., and taking into consideration suitability such as field and experience case number.

(2) In an illustrative embodiment, the client terminal of any staffer among a plurality of staff members who are customer assistants is assigned with the user terminal of a user who is the poster of retrieved posts, but other embodiments are not limited to such a configuration. For example, a meaningful post and its response may be made available to other staff people for use as a reference in future responses. In this way, when including other staffers in giving news of a given meaningful post is desired, it is distributed to the other staffers from the assigned staffer, which has advantages including that thorough publicizing of the meaningful post is served.

(3) In an illustrative embodiment, an email for requesting an assign with the user terminal of a user who is a poster is transmitted to the client terminal of any staffer among a plurality of staff members who are customer assistants, but embodiments are not limited to such a configuration. For example, a different embodiment may utilize the present service-support server (system). By using such a system, a message may still be easily delivered even if the recipient of the message is logged out. In other words, a logged out staffer may not receive or be assigned a post. Alternatively, a logged out staffer may receive notification that an assigned post has been attended to by a logged in staffer.

(4) Also, an embodiment may be made to execute such repeat notification-email transmission processes in situations where in online chat, the other party is away (is not logged in).

(5) In another possible embodiment, whether to adopt any repeat-notification schedule is automatically selected taking into account (monitoring with the timer 4134) time factors such as morning or afternoon, or dates and days of the week. Also, in a mode in which the age, gender, career, how packed a work schedule is, and other attribute information of the message transmission recipient is used, this information may be taken advantage of. For example, this attribute information may be used to adopt a particular repeat-notification schedule automatically. In other embodiments, the system may select a particular repeat-notification schedule based on similar attribute information about the poster of the original electronic communication on the SNS.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus comprising:
a memory; and
a processor coupled to the memory, wherein the processor is configured to:
receive a user generated electronic message;
send a first electronic message to a designated receiver, wherein the first electronic message solicits a response from the designated receiver regarding the user generated electronic message; and
send a plurality of subsequent electronic messages to the designated receiver according to a repeat-notification schedule stored in the memory until the response is received, wherein the plurality of subsequent electronic messages solicit the response, and wherein the repeat-notification schedule comprises:
a first elapsed time before sending of a second electronic message occurs; and
a second elapsed time before sending of a third electronic message occurs, wherein the second elapsed time is different than the first elapsed time.

2. The apparatus of claim 1, wherein the processor is further configured to:
receive the response from the designated receiver; and
responsive the received response, prevent subsequent electronic messages from being sent to the designated receiver.

3. The apparatus of claim 1, wherein the repeat-notification schedule further comprises a plurality of elapsed times for determining when to send the plurality of subsequent electronic messages, wherein the plurality of elapsed times are gradually lengthening.

4. The apparatus of claim 1, wherein the processor is further configured to receive a selection of the repeat-notification schedule from a plurality of repeat-notification schedules, wherein different repeat-notification schedules in the plurality of repeat-notification schedules comprise differing values for the first elapsed time and the second elapsed time.

5. The apparatus of claim 1, wherein the processor is further configured to determine the repeat-notification schedule based on an urgency level of the electronic message.

6. The apparatus of claim 1, wherein the processor is further configured to determine the repeat-notification schedule based on an identity of the designated receiver.

7. The apparatus of claim 6, wherein the identity of the designated receiver comprises:
a job title of the designated receiver; and
a workload of the designated receiver.

8. The apparatus of claim 1, wherein the first electronic message comprises:
a request to follow-up on a social media post; and
a link to an electronic message address of an author of the social media post or a link to the social media post.

9. The apparatus of claim 8, wherein the processor is further configured to determine the repeat-notification schedule based on content of the social media post.

10. The apparatus of claim 8, wherein the processor is further configured to determine the repeat-notification schedule based on an identity of the author of the social media post.

11. The apparatus of claim 1, wherein the repeat-notification schedule comprises a set number of electronic messages to send including a final notification electronic message, and wherein the processor is further configured to send the final notification electronic message to a second designated receiver, wherein the second designated receiver is different from the designated receiver.

12. A method comprising:
receiving, by a processor of a terminal, a user generated electronic message;
sending, by the processor of the terminal, a first electronic message to a designated receiver, wherein the first electronic message solicits a response from the designated receiver regarding the user generated electronic message; and
sending, by the processor of the terminal, a plurality of subsequent electronic messages to the designated receiver according to a repeat-notification schedule stored in a memory until the response is received, wherein the plurality of subsequent electronic messages solicit the response, and wherein the repeat-notification schedule comprises:
a first elapsed time before sending of a second electronic message occurs; and
a second elapsed time before sending of a third electronic message occurs, wherein the second elapsed time is different than the first elapsed time.

13. The method of claim 12, wherein the designated receiver is a customer service representative, wherein the electronic message comprises a request to follow-up on a social media post, and further wherein the response comprises a follow-up on the social media post from the designated receiver.

14. The method of claim 12, wherein the repeat-notification schedule further comprises a third elapsed time before sending of a fourth electronic message occurs, wherein the second elapsed time is longer than the first elapsed time, and wherein the third elapsed time is longer than the second elapsed time.

15. The method of claim 12, wherein the first electronic message comprises:
a request to follow-up on a social media post, wherein the social media post is a complaint about a product; and
a link to an electronic message address of the author of the social media post or a link to the social media post; and
wherein the response comprises a resolution of the complaint about the product.

16. The method of claim 12, further comprising:
receiving, by the processor of the terminal, the response before the first elapsed time has elapsed; and
preventing, by the processor of the terminal, subsequent electronic messages from being sent.

17. A non-transitory computer readable medium having instructions stored thereon for execution by a processor, the instructions comprising:
instructions to receive, by a processor, a user generated electronic message;
instructions to send, by the processor, a first electronic message to a designated receiver, wherein the first electronic message solicits a response from the designated receiver regarding the user generated electronic message; and
instructions to send, by the processor, a plurality of subsequent electronic messages to the designated receiver according to a repeat-notification schedule stored in the non-transitory computer readable medium until the response is received, wherein the plurality of subsequent electronic messages solicit the response, and wherein the repeat-notification schedule comprises:
a first elapsed time before sending of a second electronic message occurs; and
a second elapsed time before sending of a third electronic message occurs, wherein the second elapsed time is different than the first elapsed time.

18. The non-transitory computer readable medium of claim 17, further comprising:
instructions to send, by the processor, the second electronic message, wherein the second electronic message solicits a response to the second electronic message; and
instructions to receive, by the processor, the response before the second elapsed time has elapsed; and
instructions to prevent, by the processor, sending of the third message responsive to the received response.

19. The non-transitory computer readable medium of claim 17, wherein the repeat-notification schedule specifies gradually lengthening intervals between each of the plurality of subsequent electronic messages.

20. The non-transitory computer readable medium of claim 17, further comprising instructions to receive, by the processor, a selection of the repeat-notification schedule from a plurality of repeat-notification schedules, wherein the plurality of repeat-notification schedules have gradually lengthening notification intervals that differ from one another.
